(19) United States
(12) Patent Application Publication
(10) Pub. No.: US 2025/0126265 A1
(43) Pub. Date: Apr. 17, 2025

(54) Adaptive Selection Of Entropy Coding Parameters

(71) Applicant: HUAWEI TECHNOLOGIES CO., LTD., Shenzhen (CN)

(72) Inventors: Timofey Mikhailovich SOLOVYEV, Munich (DE); Georgii Petrovich GAIKOV, Moscow (RU); Maxim Borisovitch SYCHEV, Moscow (RU); Alexander Alexandrovich KARABUTOV, Munich (DE); Sergey Yurievich IKONIN, Moscow (RU)

(21) Appl. No.: 19/002,140

(22) Filed: Dec. 26, 2024

Related U.S. Application Data
(63) Continuation of application No. PCT/RU2022/000208, filed on Jun. 30, 2022.

(51) Int. Cl. H04N 19/13; H04N 19/184; H04N 19/196

(52) U.S. Cl. CPC H04N 19/13; H04N 19/184; H04N 19/196

(57) ABSTRACT

Methods and apparatuses are described to encoded data into a bitstream and to decode data from a bitstream. A decoding method including: receiving a bitstream including encoded data of an input signal and a first parameter; parsing the bitstream to obtain the first parameter; obtaining an entropy coding parameter based on the first parameter; reconstructing at least a portion of the input signal, based on the entropy coding parameter and the encoded data. Due to adaptiveness of the entropy coding parameters, the optimal work of the entropy coder is possible on low bitrates which results in the bitrate saving; and the absence of clipping effect is achieved on high bitrates, which results in higher reconstruction signal quality.

### CROSS-REFERENCE TO RELATED APPLICATIONS

This application is a continuation of International Application No. PCT/RU2022/000208, filed on Jun. 30, 2022, the disclosure of which is hereby incorporated by reference in its entirety.

### TECHNICAL FIELD

The present disclosure relates to entropy encoding and decoding. In particular, the present disclosure relates to adaptive selection of entropy coding parameters.

### BACKGROUND

Video coding (video encoding and decoding) is used in a wide range of digital video applications, for example broadcast digital TV, video transmission over internet and mobile networks, real-time conversational applications such as video chat, video conferencing, DVD and Blu-ray discs, video content acquisition and editing systems, mobile device video recording, and camcorders of security applications.

The amount of video data needed to depict even a relatively short video can be substantial, which may result in difficulties when the data is to be streamed or otherwise communicated across a communications network with limited bandwidth capacity. With limited network resources and ever increasing demands of higher video quality, improved compression and decompression techniques that improve compression ratio with little to no sacrifice in picture quality are desirable. The encoding and decoding of the video may be performed by standard video encoders and decoders, compatible with H.264/AVC, HEVC (H.265), VVC (H.266) or other video coding technologies, for example. Moreover, the video coding or its parts may be performed by neural networks.

In any encoding or decoding or still pictures or images or other source signal such as feature channels of a neural network, entropy coding has been widely used. The input alphabet for entropy encoder is finite and size of the input alphabet should be known both on encoder and decoder sides. Coder with bigger size of input alphabet allows to encode wider symbol range, but has less efficiency than the same coder with smaller input alphabet. Due to such effect, it's optimal to use as small alphabet as possible. In conventional method, entropy coding parameters, in particular the input alphabet size, are predefined and used for all possible input signals, which will cause clipping effect under high bitrate conditions and unreasonable waste of bits under low bitrate conditions. As a result, reconstruction quality and coding efficiency will be degraded.

### SUMMARY

The embodiments of the present disclosure provide apparatuses and methods for entropy encoding of data into a bitstream and entropy decoding of data from a bitstream.

The embodiments of the invention are defined by the features of the independent claims, and further advantageous implementations of the embodiments by the features of the dependent claims.

According to a first aspect, an embodiment of this application provides a decoding method that is implemented by a decoder, the decoding method including: receiving a bitstream including encoded data of an input signal and a first parameter; parsing the bitstream to obtain the first parameter; obtaining an entropy coding parameter based on the first parameter; reconstructing at least a portion of the input signal, based on the entropy coding parameter.

In the conventional methods, the entropy coding parameters are usually predefined, for example, an alphabet size M is usually predefined by selecting once based on expected tensor range (or latent tensor range) and using the predefined alphabet size M for all cases. Since a size of an input alphabet of an entropy encoder is the same as a size of an output alphabet of an entropy decoder, so the alphabet size M here represents the size of the input alphabet of the entropy encoder, or the size of the output alphabet of the entropy decoder. In such case, if the real tensor range is wider than the expected tensor range, the input alphabet size determined based on the expected tensor range will not be suitable, then clipping is needed for coded tensor values. Such a clipping corrupts the signal, especially if coded tensor range differs a lot from the alphabet size. Corruption of the coded tensor in this case is non-linear distortion which cause unpredictable errors in reconstruction signal, so the quality of the reconstructed signal can suffer quite significantly. In one implementation, extremely large alphabet size can be selected and can be used for all cases, but increasing the alphabet size penalizes compression efficiency for low bitrate conditions, usage of big alphabet size will result in bitrate increasing significantly but will not improve reconstruction quality.

In the embodiments of this application, the decoder can obtain entropy coding parameter (in particular alphabet size) based on parameters carried in the bitstream, since the parameters carried in the bitstream can be changed, the encoder is able to adjust the entropy encoding parameters adaptively by changing the parameters carried in the bitstream. Thus, clipping effect can be avoided on high bitrates conditions, and the rate overhead caused by unreasonably big alphabet size for the low bitrates conditions can be avoided as well. In other words, due to adaptiveness of the entropy coding parameters, in particular the alphabet size, the optimal work of the entropy coder is possible on low bitrates (corresponding to narrow range of coded values) which results in the bitrate saving; and the absence of clipping effect is achieved on high bitrates (corresponding to wide range of coded values), which results in higher reconstruction signal quality.

It has to be noted here that “entropy coder” can be used as a synonym of “entropy coding algorithm”, which includes both encoding and decoding algorithms. The entropy encoder may be a module, which is a part of the encoder; and the entropy decoder may be another module, which in turn is a part of the decoder. Parameters of entropy coder and entropy decoder should be synchronized for correct work, so, the term “parameters for entropy coder” or “entropy coding parameter” mean parameters for both entropy encoder and entropy decoder. In other words, “entropy coding parameter” can be equaled as “parameters of entropy encoder and entropy decoder”. The entropy encoder encodes symbols of the alphabet to one or more bits in a bitstream and the entropy decoder decodes one or more bits in the bitstream to the symbols of the alphabet. At entropy encoder side, the alphabet means an input alphabet, while at entropy decoder side, the alphabet means an output alphabet. A size of an input alphabet at entropy encoder side is equal to a size of an output alphabet at entropy decoder side.

In one possible embodiment, the input signal includes video data, image data, point claud data, motion flow, or motion vectors or any other type of media data.

In one possible embodiment, the entropy coding parameter includes at least one of the following: a size of an alphabet of an entropy coder, where the size of the alphabet is: a size of an input alphabet of an entropy encoder, or a size of an output alphabet of an entropy decoder; or minimum symbol probability supported by the entropy coder; or renormalization period of the entropy coder. In some embodiments, the renormalization period can be 8 bits, 16 bits, etc.

Three possible schemas of alphabet size derivation based on bitstream are considered:
1) Explicit signalling with predefined predictor;
2) Derivation from quantization parameter (B);
3) Explicit signalling with predictor depending on quantization parameter;

Technology can be applied for any type of coders which use entropy coding in the pipeline.

In one possible embodiment, the first parameter is the size of the alphabet; where the obtaining the entropy coding parameter based on the first parameter, including: using the first parameter as the size of the alphabet.

In this embodiment, the alphabet size is signaled directly in the bitstream, e.g. with fixed-length coding, exp-Golomb coding, or some other coding algorithm. Typical values of M can be 256, 512, 1024, for example, for signaling 1024 with, e.g. fixed-length code, 11 bits is needed (1024₁₀=10000000000₂) and for signaling log₂(1024)−9=1, that is only 1 bit is needed if only values 512 and 1024 are allowed, or 2 bits are needed if 4 different alphabet sizes like 512, 1024, 2048, 4096 are allowed. As a result, direct signaling of M will cost more bits. But for some exotic cases (e.g. alphabet size M is not the power of two) direct signaling of M can be helpful.

In one possible embodiment, the first parameter is p, the entropy coding parameter includes the size of the alphabet M, and M is a function of p.

In one possible embodiment, the obtaining the entropy coding parameter based on the first parameter, including: M=f⁻¹(p); where f⁻¹(p) is an inverse function of f(M), f(M)=p.

In this embodiment, an output p of some reversible function ƒ(M) instead of M itself is signaled in the bitstream. Such p can be signaled with fixed-length coding, exp-Golomb coding, or some other coding algorithm. Accordingly, on decoder side M is derived based on p, specifically, M is derived as M=f⁻¹(p). The benefit of the above embodiment is that any optimal alphabet size selected on the encoder-side can be signaled, so the flexibility of signaling the alphabet size is increased. In some embodiments, p is greater than or equal to 0, but in other embodiments it can also be negative. For example, value p can be within the range [0, 5] and 3 bits are used for the signaling. The function ƒ(M) can be negotiated between the encoder side and the decoder side in advance.

In one possible embodiment, M meets one of the following: M=k\hat{ }p, where k is natural number; or, M=k\hat{ }(p+C), where k is natural number, C is integer number; or M=k\hat{ }(a*p+C), where k is natural number, a and C are constants; or, M=a*p+b, where a and b are constants; or, M=p\hat{ }2. It has to be noted that in any one of the embodiments A\hat{ }B means A^{B}.

In one possible embodiment, p=log₂(M)−9, and M=f⁻¹(p)=2\hat{ }(p+9), where f⁻¹(p) is the an inverse function of ƒ(M), where ƒ(M)=log₂(M)−9.

In one possible embodiment, p is signaled using one of the following codes: binary code; or unary code; or truncated unary code; or exp-Golomb code.

In one possible embodiment, p is signaled using order 0 exp-Golomb code.

In one possible embodiment, the alphabet size is signaled e.g. in a parameter set section in the bitstream, e.g. in a Picture Parameter Set section of the bitstream.

In one possible embodiment, the first parameter includes at least one of the following: a rate control parameter, a quantization parameter (qp), image resolution, video resolution, framerate, density of pixels in 3D object, or rate-distortion weighting factor.

In the above embodiment, the alphabet size can be derived based on some other parameters. In one exemplary implementation the alphabet size is derived from the quantization parameter or rate control parameter, alternatively the alphabet size can be derived from the image resolution, video resolution, framerate, density of pixels in 3D object and so on. In trainable codecs, the alphabet size can be derived from some parameters of the loss function used during the training, for example weighting factor for rate/distortion, or some parameters which affects gain vector g selection. The loss function might include rate and distortion components, such as Peak signal-to-noise ratio (PSNR), Multi-Scale Structural Similarity index (MS-SSIM), Video Multimethod Assessment Fusion (VMAF) or some other quality metric. For example, the loss function can be: loss=beta*distortion+bits, where the distortion is measured with PSNR or MS-SSIM or VMAF, bits is number of spent bits, and beta is a weighting parameter which controls the ratio between the bitrate and the reconstruction quality, and beta can also be called as rate control parameter. Also it could be quantization parameter, like quantization parameter (qp) in regular codecs like JPEG, HEVC, VVC.

The benefit of the above embodiment is that since quantization parameters or rate control parameters are already exist in the bitstream and are used for other procedure, such parameters can be used by the decoder side to derive the alphabet size M, there is no need for additional signaling for information specifically used to indicate the alphabet size M, so bitrate can be saved.

In one possible embodiment, the obtaining the entropy coding parameter based on the first parameter, including: determining a target sub-range in which the first parameter is located; where an allowed range of values of the first parameter includes a plurality of sub-ranges, the target sub-range is one of the plurality of sub-ranges; and each of the plurality of sub-ranges includes at least one value of the first parameter, and each of the plurality of sub-ranges corresponds to one value of the entropy coding parameter; using a value of the entropy coding parameter corresponding to the target sub-range as the value of the entropy coding parameter; or, calculating the value of the entropy coding parameter based on one or more values of the entropy coding parameters corresponding to one or more sub-ranges neighboring the target sub-range.

In the above embodiment, denote such a rate control parameter as β, the range of betas(β) is split into K intervals (K sub-ranges) as follows:
[β_0,β_1), [β_1,β_2), . . . , [β_(K−1), β_K)

Each one of the intervals/sub-range corresponds to one alphabet size value Mi. It should be noticed, there will be a range of allowed for particular codec values β; e.g. for some codecs β can be allowed to be within the range [−∞,∞], for the other codecs β can be allowed to be only within the range [0, ∞]. Within the context of this embodiment, the original big range of allowed β values is split to a few sub-ranges and for the every sub-range there is a specific value of the alphabet size. After obtaining parameter β, the decoder can choose the target interval based on the β value obtained from the bitstream. For specific, the decoder determines that β_i≤β≤β_(i+1), then the interval [β_i,β_(i+1)] is chosen as the target interval, and the alphabet size value Mi corresponding to this target interval is derived as the alphabet size value M by the decoder side. In some embodiments, each βi in the range of betas {βi} can correspond to one alphabet size value Mi, and the alphabet size value M corresponding to the particular β is calculated based on one or more values Mi corresponding to βi neighboring for β. It should be noted that the values used for calculating M could be the just values Mi of the nearest neighbor corresponding to the target interval, or it could be linear or bilinear or some other interpolation from the two or more Mi corresponding to βi neighboring for β, or some other interpolation from the two or more Mi corresponding to the intervals neighboring to the target interval.

In one possible embodiment, the first parameter is D, the entropy coding parameter includes the size of alphabet M, where M is obtained based on P and D, where P is a predictor that can be derived by a decoder.

In the above embodiment, the alphabet size can be derived based on a predictor P and the first parameter signaled in the bitstream. Thus, when a bitstream is received, the decoder derives the predictor P based on predefined parameters, and parses the first parameter from the bitstream, and then the alphabet size M can be derived based on the predictor P and the first parameter. The benefit of the above embodiment is that since only the difference between the P and M is signaled in the bitstream, additional bits spent is reduced comparing with M signaled in the bitstream. Besides, difference between the P and M can be selected based on the content or the bitrate, the flexibility of signaling the alphabet size is also increased. Thus, this embodiment provides alphabet size selection flexibility with minimal additional bits spent to the signaling. In some rare cases when the alphabet size predicted from β works bad, encoder still can signal the difference value between M and P. It will cost a few bits, but can solve serious problems with the clipping effect.

In one possible embodiment, the obtaining the entropy coding parameter based on the first parameter, including: M=s⁻¹(D,P); where s⁻¹(D,P) is an inverse function of s(M,P), s(M,P)=D.

In one possible embodiment, s(M,P) includes as follows: s(M,P)=logₖ(M)−logₖ(P), where k is natural number; or, s(M,P)=logₖ(P)−logₖ(M), where k is natural number; or, s(M,P)=logₖ(M)−logₖ(P)−C, where k is natural number, C is integer number; or, s(M,P)=logₖ(P)−logₖ(M)−C, where k is natural number, C is integer number; or, s(M,P)=a*logₖ(P)−b*logₖ(M)−c, where k is natural number, a, b and c are constants; or, s(M,P)=a*M+b*P+c, where a, b and c are constants.

In one possible embodiment, M=2\hat{ }(D+log 2(P)), D=s(M,P)=log₂(M)−log₂(P).

It has to be noted that the reversible function D=s(M,P) can be considered as D=s_{P}(M), and M=s⁻¹(D,P) can be considered as M=s⁻¹_{P}(D), where P can be any fixed number, or in other words, P is a constant coefficient.

In one possible embodiment, D is signaled using one of the following codes: binary code; or unary code; or truncated unary code; or exp-Golomb code.

In one possible embodiment, D is signaled using order 0 exp-Golomb code.

In one possible embodiment, P can be derived based on at least one parameter other than the first parameter carried in the bitstream.

In one possible embodiment, the at least one parameters other than the first parameter includes at least one of the following: rate control parameter, quantization parameter (qp), image resolution, video resolution, framerate, density of pixels in 3D object, or rate-distortion weighting factor.

In one possible embodiment, P is derived based on the at least one parameters including: obtaining a rate control parameter beta (β) from the bitstream; determining a target sub-range in which the obtained β is located; where an allowed range of the values of the rate control parameter β is [β_0, β_K], and the allowed range [β_0, β_K] includes a plurality of sub-ranges, the target sub-range is one of the plurality of sub-ranges; each of the plurality of sub-ranges includes at least one value of B, and each of the plurality of sub-ranges corresponds to one value of P; choosing a value corresponding to the target sub-range as the value of P; or, calculating the value of P based on one or more values corresponding to one or more sub-ranges neighboring the target sub-range.

In one possible embodiment, the decoding method further including: parsing the bitstream to obtain a flag, where the flag is used to indicate whether the entropy coding parameter is carried in the bitstream directly.

In the above embodiment, a flag can be introduced into the bitstream to indicate switching between three embodiments, in this case, two bits might be needed for this flag. In another possible embodiment, a flag can be used to indicate switching between two embodiments, in this case, only one bit is needed.

In one possible embodiment, when the flag is equal to a first value specifies that the entropy coding parameter is carried in the bitstream, and in this case, the first parameter is the entropy coding parameter or the first parameter is a transformation result of the entropy coding parameter; or when the flag is equal to a second value specifies that the entropy coding parameter is not carried in the bitstream, and the entropy coding parameter can be derived by a decoder.

Such a solution provide a balance between bit saving and flexibility: for the most cases, where the derived entropy parameter is appropriate, only one bit is spent for the indication and from the other side in some specific cases there is a possibility to signal the entropy parameter explicitly.

In one possible embodiment, when the flag is equal to a third value specifies that a difference value between M and P, or a transformation result of the difference value between M and P is carried in the bitstream, in this case, the first parameter is the difference value between M and P, or a transformation result of the difference value between M and P, where M is the size of input alphabet, and P is a predictor that can be derived by the decoder.

In one possible embodiment, the entropy coder is an arithmetic coder, or a range coder, or an asymmetric numerical systems (ANS) coder.

In one possible embodiment, the reconstructing at least a portion of the input signal, based on the entropy coding parameter, including: obtaining at least one probability model, where a probability model of an output symbol is used to indicate probability of each possible value of the output symbol; entropy decoding, one or more bits in the bitstream, by using the at least one probability model and the entropy coding parameter, to obtain one or more output symbols; reconstructing the at least a portion of the input signal based on the one or more output symbols.

In one possible embodiment, the method further including: updating the probability model. For example, the probability model is updated after each output symbol; so every output symbol has its own probability distribution of the possible values. It has to be noted that probability model can also be called as probability distribution.

In one possible embodiment, the probability model is depended on the entropy coding parameter. For example, symbol probabilities are distributed according to the normal distribution N(μ,σ), where N(μ,σ) means Gaussian Distribution with mean value equal to μ and variance equal to σ². But the actual probability model (also means mathematical model or theoretic model), such as a quantized histogram depends on the alphabet size and probability precision within the entropy coding engine or entropy coder. That is, the entropy coding parameter might affect the histogram construction inside the entropy coder. Basically, the alphabet size is a number of possible symbol values, so if, e.g. the alphabet size is equal to 4 then bigger values, e.g. value “7” cannot be encoded/decoded. The histogram used in the entropy coder consists of the quantized probabilities of each symbol value: e.g. alphabet is {0,1,2,3}, and corresponding probabilities are { 7/16, 7/16, 1/16, 1/16}—each probability is non-zero, sum of the probabilities is equal to 1; also each of the probabilities is more than the minimal probability supported by the entropy coding engine (probability precision) ( 1/16 in this example). If probabilities of some symbols are lower than the minimal probability supported by the entropy coding engine, the probabilities of at least some symbols need to be adjusted to insure that probabilities of each symbols are more than the minimal probability supported by the entropy coding engine.

According to a second aspect, an embodiment of this application provides a decoding method for entropy decoding a bitstream, the method including: receiving a bitstream including decoded data of an input signal; parsing the bitstream to obtain a flag, where the flag is used to indicate whether an entropy coding parameter is carried in the bitstream; obtaining the entropy coding parameter based on the flag; reconstructing at least a portion of the input signal, based on the entropy coding parameter.

In the above embodiment, a flag can be introduced into the bitstream to indicate switching between three embodiments, in this case, two bits might be needed for this flag. In another possible embodiment, a flag can be used to indicate switching between two embodiments, in this case, only one bit is needed. Such a solution provide a balance between bit saving and flexibility: for the most cases, where the derived entropy parameter is appropriate, only one bit is spent for the indication and from the other side in some specific cases there is a possibility to signal the entropy parameter explicitly.

In one possible embodiment, the entropy coding parameter includes at least one of the following: a size of an alphabet of an entropy coder, where the size of the alphabet is: a size of an input alphabet of an entropy encoder, or a size of an output alphabet of an entropy decoder; or minimum symbol probability supported by the entropy coder; or renormalization period of the entropy coder.

In one possible embodiment, when the flag is equal to a first value specifies that the entropy coding parameter is carried in the bitstream, or a transformation result of the entropy coding parameter is carried in the bitstream; or where when the flag is equal to a second value specifies that the entropy coding parameter is not carried in the bitstream, but the entropy coding parameter can be derived by the decoder.

In one possible embodiment, when the flag is equal to a third value specifies that a difference value between M and P is carried in the bitstream, or a transformation result of the difference value between M and P is carried in the bitstream, where M is the entropy coding parameter, and P is a predictor that can be derived by the decoder.

In one possible embodiment, the obtaining the entropy coding parameter based on the flag, including: when the flag is equal to the first value, parsing the bitstream to obtain a first parameter; where the first parameter is the entropy coding parameter; using the first parameter as the entropy coding parameter; or, where the first parameter is the transformation result of the entropy coding parameter; obtaining entropy coding parameter based on the first parameter.

In one possible embodiment, the transformation result of the entropy coding parameter is p=f(M), where M is the entropy coding parameter, f(M) includes as follows: f(M)=logₖ(M), k is natural number; or, f(M)=a*logₖ(M)−C, where k is natural number, a and C are predefined constants; or, f(M)=a*M+R, where a and R are predefined constants; or, f(M)=sqrt (M); where the obtaining entropy coding parameter based on the first parameter, includes: M=f⁻¹(p); where f⁻¹(p) is the inverse function of f(M).

In one possible embodiment, the first parameter is p=log₂(M)−9.

In one possible embodiment, the obtaining the entropy coding parameter based on the flag, including: when the flag is equal to the second value, parsing the bitstream to obtain a second parameter, where the second parameter includes at least one of: a rate control parameter, a quantization parameter (qp), image resolution, video resolution, framerate, density of pixels in 3D object, or rate-distortion weighting factor; deriving the entropy coding parameter based on the second parameter.

In one possible embodiment, the deriving the entropy coding parameter based on the second parameter including: determining a target sub-range in which the second parameter is located; where an allowed range of values of the second parameter includes a plurality of sub-ranges, the target sub-range is one of the plurality of sub-ranges; and each of the plurality of sub-ranges includes at least one value of the second parameter, and each of the plurality of sub-ranges corresponds to one value of the entropy coding parameter; using a value of the entropy coding parameter corresponding to the target sub-range as the value of the entropy coding parameter; or, calculating the value of the entropy coding parameter based on one or more values of the entropy coding parameters corresponding to one or more sub-ranges neighboring the target sub-range.

In one possible embodiment, the obtaining the entropy coding parameter based on the flag, including: when the flag is equal to the third value, parsing the bitstream to obtain a third parameter, where the third parameter is the difference value between M and P, or the third parameter is a transformation result of the difference value between M and P; where M is the entropy coding parameter, and P is a predictor that can be derived by the decoder; deriving P based on at least one of: a rate control parameter, a quantization parameter (qp), image resolution, video resolution, framerate, density of pixels in 3D object, or rate-distortion weighting factor; obtaining entropy coding parameter based on the third parameter and P.

In one possible embodiment, the transformation result of the difference value between M and P is D=s(M,P), s(M,P) is a reversible function; where s(M,P) includes as follows:
s(M,P)=logₖ(M)−logₖ(P), where k is natural number; or,
s(M,P)=logₖ(P)−logₖ(M), where k is natural number; or,
s(M,P)=logₖ(M)−logₖ(P)−C, where k is natural number, C is integer number; or,
s(M,P)=logₖ(P)−logₖ(M)−C, where k is natural number, C is integer number; or,
s(M,P)=a*logₖ(P)−b*logₖ(M)−c, where k is natural number, a, b and c are constants; or,
s(M,P)=a*M+b*P+c, where a, b and c are constants;
   where the obtaining entropy coding parameter based on the third parameter, including: M=s⁻¹(D,P); where s⁻¹(D,P) is the inverse function of s(M,P).

According to a third aspect, an embodiment of this application provides an encoding method that is implemented by an encoder, the method including: encoding input signal and a first parameter into a bitstream; where the first parameter is used to obtain an entropy coding parameter; transmit the bitstream to a decoder.

In the embodiments of this application, the decoder can obtain entropy coding parameter (in particular alphabet size) based on parameters carried in the bitstream, since the parameters carried in the bitstream can be changed, the encoder is able to adjust the entropy encoding parameters adaptively by changing the parameters carried in the bitstream. Thus, clipping effect can be avoided on high bitrates conditions, and the rate overhead caused by unreasonably big alphabet size for the low bitrates conditions can be avoided as well. In other words, due to adaptiveness of the entropy coding parameters, in particular the alphabet size, the optimal work of the entropy coder is possible on low bitrates (corresponding to narrow range of coded values) which results in the bitrate saving; and the absence of clipping effect is achieved on high bitrates (corresponding to wide range of coded values), which results in higher reconstruction signal quality.

In one possible embodiment, the entropy coding parameter includes at least one of the following: a size of an alphabet of an entropy coder, where the size of the alphabet is: a size of an input alphabet of an entropy encoder, or a size of an output alphabet of an entropy decoder; or minimum symbol probability supported by the entropy coder; or renormalization period of the entropy coder.

In one possible embodiment, the first parameter is the size of alphabet.

In one possible embodiment, the first parameter is p, where p is a transformation result of M, and M is the entropy coding parameter.

In one possible embodiment, p=f(M), where f(M) is a reversible function.

In one possible embodiment, f(M) includes as follows:
f(M)=a*logₖ(M)−C, where k is natural number, a and C are predefined constants; or,
f(M)=a*M+b, where a and b are constants; or,
f(M)=sqrt (M).

In one possible embodiment, p=log₂(M)−9.

In one possible embodiment, p is signaled using one of the following codes: binary code; or unary code; or truncated unary code; or exp-Golomb code.

In one possible embodiment, the first parameter includes at least one of the following: a rate control parameter, a quantization parameter (qp), image resolution, video resolution, framerate, density of pixels in 3D object, or rate-distortion weighting factor; where the first parameter is used by the entropy decoder to derive the entropy coding parameter.

In one possible embodiment, the first parameter is D that is obtained based on P and M, where M is the entropy coding parameter, and P is a predictor that can be derived by a decoder.

In one possible embodiment, D=s(M,P), where s(M,P) is a reversible function.

In one possible embodiment, s(M,P) includes as follows:
s(M,P)=logₖ(M)−logₖ(P), where k is natural number; or,
s(M,P)=logₖ(P)−logₖ(M), where k is natural number; or,
s(M,P)=logₖ(M)−logₖ(P)−C, where k is natural number, C is integer number; or
s(M,P)=logₖ(P)−logₖ(M)−C, where k is natural number, C is integer number; or,
s(M,P)=a*logₖ(P)−b*logₖ(M)−c, where k is natural number, a, b and c are constants; or,
s(M,P)=a*M+b*P+c, where a, b and c are constants.

In one possible embodiment, D=s(M,P)=log₂(P)−log₂(M).

In one possible embodiment, D is signaled using one of the following codes: binary code; or unary code; or truncated unary code; or exp-Golomb code.

In one possible embodiment, the encoding method further including: encoding a flag into the bitstream, where the flag is used to indicate whether the entropy coding parameter is carried in the bitstream directly.

In one possible embodiment, when the flag is equal to a first value specifies that the entropy coding parameter is carried in the bitstream, and the first parameter is the entropy coding parameter or the first parameter is a transformation result of the entropy coding parameter; or where when the flag is equal to a second value specifies that the entropy coding parameter is not carried in the bitstream, but the entropy coding parameter can be derived by a decoder.

In one possible embodiment, when the flag is equal to a third value specifies that a difference value between M and P is carried in the bitstream, or a transformation result of the difference value between M and P is carried in the bitstream, where M is the entropy coding parameter, and P is a predictor that can be derived by the decoder.

In one possible embodiment, several possible solutions are proposed for alphabet selection on encoder-side.

In one possible embodiment, the method further including: obtaining minimum value and maximum value of latent space elements of the entropy encoder; where the latent space elements are result of procession of the input signal; obtaining the size of the alphabet as follows:

M=ceil(max{y}−min{y}), or M=2\hat{ }(ceil(log₂(max{y}−min{y}))),

where, ceil(x) is the smallest integer number higher than x, max{y} indicates the maximum value of the latent space elements, min{y} indicates the minimum value of the latent space elements, and M indicates the size of the alphabet.

In this embodiment, the alphabet size is selected as the minimal possible number higher than the coded values range. For example, minimum and maximum values for tensor y are obtained first and alphabet size is selected as:

M=ceil(max{y}−min{y}),

For most of the entropy coders the alphabet size should be the power of 2, the alphabet size in this case can be selected as M=2\hat{ }(ceil(log₂(max{y}−min{y}))). It should be noticed that there are some cases, e.g. when module of all y values is smaller than 1, the additional scaling operation can be performed before the entropy coding.

In one possible embodiment, the method further including: obtaining at least two values around M₀, where M₀=ceil(max{y}−min{y}), or M₀=2\hat{ }(ceil(log₂(max{y}−min{y}))); calculating loss function for the at least two values; selecting a value with a minimal loss function among the at least two values as the size of the alphabet; where ceil(x) is the smallest integer number higher than x, max{y} indicates the maximum value of the latent space elements, min{y} indicates the minimum value of the latent space elements.

The loss function might include rate and distortion components, for example, the loss function can be as following: loss-beta*distortion+bits, where the distortion is measured with such as Peak signal-to-noise ratio (PSNR), Multi-Scale Structural Similarity index (MS-SSIM), Video Multimethod Assessment Fusion (VMAF) or some other quality metric, bits is number of spent bits, and beta is a weighting parameter which controls the ratio between the bitrate and the reconstruction quality, and beta can also be called as rate control parameter. Within this approach clipping can occurs sometimes, but the bitrate saving due to usage of smaller alphabet compensate minor distortion increase.

According to a fourth aspect, an embodiment of this application provides an encoding method that is implemented by an encoder, the method including: encoding input signal and a flag into a bitstream, where the flag is used to indicate whether an entropy coding parameter is carried in the bitstream directly; and transmit the bitstream to a decoder.

In the above embodiment, a flag can be introduced into the bitstream to indicate switching between three embodiments, in this case, two bits might be needed for this flag. In another possible embodiment, a flag can be used to indicate switching between two embodiments, in this case, only one bit is needed. Such a solution provide a balance between bit saving and flexibility: for the most cases, where the derived entropy parameter is appropriate, only one bit is spent for the indication and from the other side in some specific cases there is a possibility to signal the entropy parameter explicitly.

In one possible embodiment, the entropy coding parameter includes at least one of the following: a size of an alphabet of an entropy coder, where the size of the alphabet is: a size of an input alphabet of an entropy encoder, or a size of an output alphabet of an entropy decoder; or minimum symbol probability supported by the entropy coder; or renormalization period of the entropy coder.

In one possible embodiment, when the flag is equal to a first value specifies that the entropy coding parameter is carried in the bitstream, or transformation result of the entropy coding parameter is carried in the bitstream; or where when the flag is equal to a second value specifies that the entropy coding parameter is not carried in the bitstream, but the entropy coding parameter can be derived by a decoder.

In one possible embodiment, when the flag is equal to a third value specifies that a difference value between M and P is carried in the bitstream, or a transformation result of the difference value between M and P is carried in the bitstream, where M is the entropy coding parameter, and P is a predictor that can be derived by the decoder.

In one possible embodiment, the method further including: when the flag is equal to the first value, encoding a first parameter into the bitstream; where the first parameter is the entropy coding parameter or the first parameter is a transformation result of the entropy coding parameter.

In one possible embodiment, the transformation result of the entropy coding parameter is p=f(M), where M is the entropy coding parameter, where f(M) can be as follows:
f(M)=logₖ(M), where k is natural number; or,
f(M)=a*logₖ(M)−C, where k is natural number, a and C are predefined constants; or,
f(M)=aM+b, where a and b are constants; or,
f(M)=sqrt (M).

In one possible embodiment, the first parameter is p=log₂(M)−9.

In one possible embodiment, p is signaled using one of the following codes: binary code; or unary code; or truncated unary code; or exp-Golomb code.

In one possible embodiment, p is signaled using order 0 exp-Golomb code.

In one possible embodiment, the method further including: when the flag is equal to the third value, encoding a third parameter into the bitstream, where the third parameter is the difference value between M and P, or the third parameter is a transformation result of the difference value between M and P, where M is the entropy coding parameter, and P is a predictor that can be derived by the decoder.

In one possible embodiment, the transformation result of the difference value between M and P is D=s(M,P), where s(M,P) is a reversible function; where s(M,P) includes as follows:
s(M,P)=logₖ(M)−logₖ(P), where k is natural number; or,
s(M,P)=logₖ(P)−logₖ(M), where k is natural number; or,
s(M,P)=logₖ(M)−logₖ(P)−C, where k is natural number, C is integer number; or,
s(M,P)=logₖ(P)−logₖ(M)−C, where k is natural number, C is integer number; or,
s(M,P)=a*logₖ(P)−b*logₖ(M)−c, where k is natural number, a, b and c are constants; or,
s(M,P)=a*M−b*P+c, where a, b and c are constants;
   where the obtaining entropy coding parameter based on the third parameter, including: M=s⁻¹(D,P); where s⁻¹(D,P) is the inverse function of s(M,P).

In one possible embodiment, D is signaled using one of the following codes: binary code; or unary code; or truncated unary code; or exp-Golomb code.

In one possible embodiment, D is signaled using order 0 exp-Golomb code.

According to a fifth aspect, an embodiment of this application provides a decoding apparatus, including: a receive unit, configured to: receive a bitstream including encoded data of an input signal; a parse unit, configured to: parse the bitstream to obtain a first parameter; an obtain unit, configured to: obtain an entropy coding parameter based on the first parameter; a reconstruction unit, configured to: reconstruct at least a portion of the input signal, based on the entropy coding parameter.

The apparatuses provide the advantages of the methods described above.

In one possible embodiment, the input signal includes video data, image data, point claud data, motion flow, or motion vectors or any other type of media data.

In one possible embodiment, the entropy coding parameter includes at least one of the following: a size of an alphabet of an entropy coder, where the size of the alphabet is: a size of an input alphabet of an entropy encoder, or a size of an output alphabet of an entropy decoder; or minimum symbol probability supported by the entropy coder; or renormalization period of the entropy coder. In some embodiments, the renormalization period can be 8 bits, 16 bits, etc.

In one possible embodiment, the first parameter is the size of the alphabet; where the obtain unit, is further configured to: use the first parameter as the size of the alphabet.

In one possible embodiment, the first parameter is p, the entropy coding parameter includes the size of the alphabet M, and M is a function of p.

In one possible embodiment, the obtain unit, is further configured to: obtain M as M=f⁻¹(p); where f⁻¹(p) is an inverse function of f(M), where f(M)=p.

In one possible embodiment, the obtain unit, is further configured to: determine a target sub-range in which the first parameter is located; where an allowed range of values of the first parameter includes a plurality of sub-ranges, the target sub-range is one of the plurality of sub-ranges; and each of the plurality of sub-ranges includes at least one value of the first parameter, and each of the plurality of sub-ranges corresponds to one value of the entropy coding parameter; use a value of the entropy coding parameter corresponding to the target sub-range as the value of the entropy coding parameter; or, calculate the value of the entropy coding parameter based on one or more values of the entropy coding parameters corresponding to one or more sub-ranges neighboring the target sub-range.

According to a sixth aspect, an embodiment of this application provides a decoding apparatus, including: functional units to implement the encoding method in the second aspect, or any one of possible embodiments of the second aspect.

The apparatuses provide the advantages of the methods described above.

According to a seventh aspect, an embodiment of this application provides an encoding apparatus, including: an encoding unit, configured to: encode input signal and a first parameter into a bitstream; where the first parameter is used to obtain an entropy coding parameter; a transmit unit, configured to transmit the bitstream to a decoder. The encoding apparatus further including other functional units to implement the encoding method in any one of possible embodiments of the third aspect.

According to an eighth aspect, an embodiment of this application provides an encoding apparatus, including: an encoding unit, configured to: encode input signal and a flag into a bitstream; where the flag is used to indicate whether an entropy coding parameter is carried in the bitstream directly; a transmit unit, configured to transmit the bitstream to a decoder. The encoding apparatus further including other functional units to implement the encoding method in any one of possible embodiments of the fourth aspect.

According to a ninth aspect, an embodiment of this application provides a decoding apparatus, including: processing circuitry configured to: perform the decoding method described in any one of the first aspect, or the possible embodiments of the first aspect.

According to a tenth aspect, an embodiment of this application provides a decoding apparatus, including: processing circuitry configured to: perform the decoding method described in any one of the second aspect or the possible embodiments of the second aspect.

According to an eleventh aspect, an embodiment of this application provides an encoding apparatus, including: processing circuitry configured to: perform the encoding method described in any one of the third aspect or the possible embodiments of the third aspect.

According to a twelfth aspect, an embodiment of this application provides an encoding apparatus, including: processing circuitry configured to: perform the encoding method described in any one of the fourth aspect or the possible embodiments of the fourth aspect.

According to a thirteenth aspect, an embodiment of this application provides a decoder including: one or more processors; and a non-transitory computer-readable storage medium coupled to the one or more processors, where the storage medium stores programming for execution by the one or more processors, where the programming, when executed by the one or more processors, configures the decoder to carry out the method described in the first aspect or any one of the possible embodiments of the first aspect.

According to a fourteenth aspect, an embodiment of this application provides a decoder including: one or more processors; and a non-transitory computer-readable storage medium coupled to the one or more processors, where the storage medium stores programming for execution by the one or more processors, where the programming, when executed by the one or more processors, configures the decoder to carry out the method described in the second aspect or any one of the possible embodiments of the second aspect.

According to a fifteenth aspect, an embodiment of this application provides an encoder including: one or more processors; and a non-transitory computer-readable storage medium coupled to the one or more processors, where the storage medium stores programming for execution by the one or more processors, where the programming, when executed by the one or more processors, configures the decoder to carry out the method described in the third aspect or any one of the possible embodiments of the third aspect.

According to a sixteenth aspect, an embodiment of this application provides an encoder including: one or more processors; and a non-transitory computer-readable storage medium coupled to the one or more processors, where the storage medium stores programming for execution by the one or more processors, where the programming, when executed by the one or more processors, configures the decoder to carry out the method described in the fourth aspect or any one of the possible embodiments of the fourth aspect.

According to a seventeenth aspect, an embodiment of this application provides a non-transitory computer-readable medium carrying computer instructions which, when executed by a computer device or one or more processors, cause the computer device or the one or more processors to perform the method described in the first aspect or any one of the possible embodiments of the first aspect.

According to a eighteenth aspect, an embodiment of this application provides a non-transitory computer-readable medium carrying computer instructions which, when executed by a computer device or one or more processors, cause the computer device or the one or more processors to perform the method described in the second aspect or any one of the possible embodiments of the second aspect.

According to a nineteenth aspect, an embodiment of this application provides a non-transitory computer-readable medium carrying computer instructions which, when executed by a computer device or one or more processors, cause the computer device or the one or more processors to perform the method described in the third aspect or any one of the possible embodiments of the third aspect.

According to a twentieth aspect, an embodiment of this application provides a non-transitory computer-readable medium carrying computer instructions which, when executed by a computer device or one or more processors, cause the computer device or the one or more processors to perform the method described in the fourth aspect or any one of the possible embodiments of the fourth aspect.

According to a twenty-first aspect, an embodiment of this application provides a non-transitory storage medium including a bitstream encoded by the method described in the third aspect or any one of the possible embodiments of the third aspect.

According to a twenty-second aspect, an embodiment of this application provides a non-transitory storage medium including a bitstream encoded by the method described in the fourth aspect or any one of the possible embodiments of the fourth aspect.

According to a twenty-third aspect, an embodiment of this application provides a computer program stored on a non-transitory medium and including code instructions, which, when executed on one or more processors, cause the one or more processor to execute steps of the method according to any one of the foregoing aspects or any one of the possible embodiments of the foregoing aspects.

According to a twenty-fourth aspect, an embodiment of this application provides a system for delivering a bitstream, including: at least one storage medium, configured to store at least one bitstream generated by the encoding method described in the third aspect or any one of the possible embodiments of the third aspect, the fourth aspect or any one of the possible embodiments of the fourth aspect; a video streaming device, configured to obtain a bitstream from one of the at least one storage medium, and send the bitstream to a terminal device; where the video streaming device includes a content server or a content delivery server.

In one possible embodiment, further including: one or more processor, configured to perform encryption processing on at least one bitstream to obtain at least one encrypted bitstream; the at least one storage medium, configured to store the encrypted bitstream; or, the one or more processor, configured to converting a bitstream in a first format into a bitstream in a second format; the at least one storage medium, configured to store the bitstream in the second format.

In one possible embodiment, further including: a receiver, configured to receive a first operation request; and; the one or more processor, configured to determine a target bitstream in the at least one storage medium in response to the first operation request; a transmitter, configured to send the target bitstream to a terminal-side apparatus.

In one possible embodiment, the one or more processor is further configured to: encapsulate a bitstream to obtain a transport stream in a first format; and the transmitter, is further configured to: send the transport stream in the first format to a terminal-side apparatus for display; or, send the transport stream in the first format to storage space for storage.

The invention can be implemented in hardware (HW) and/or software (SW) or in any combination thereof. Moreover, HW-based implementations may be combined with SW-based implementations.

Details of one or more embodiments are set forth in the accompanying drawings and the description below. Other features, objects, and advantages will be apparent from the description, drawings, and claims.

### BRIEF DESCRIPTION OF THE DRAWINGS

In the following, embodiments of the invention are described in more detail with reference to the attached figures and drawings, in which:

FIG. 1 is a schematic drawing illustrating channels processed by layers of a neural network according to an embodiment;

FIG. 2 is a schematic drawing illustrating an autoencoder type of a neural network according to an embodiment;

FIG. 3 is a schematic drawing illustrating an exemplary network architecture for encoder and decoder side including a hyperprior model according to an embodiment;

FIG. 4 is a schematic drawing illustrating an exemplary network architecture for encoder and decoder side including a hyperprior model according to an embodiment;

FIG. 5 is a block diagram illustrating a structure of a cloud-based solution for machine based tasks such as machine vision tasks according to an embodiment;

FIG. 6A is a block diagram illustrating end-to-end video compression framework based on a neural networks according to an embodiment;

FIG. 6B is a block diagram illustrating some exemplary details of application of a neural network for motion field compression according to an embodiment;

FIG. 6C is a block diagram illustrating some exemplary details of application of a neural network for motion compensation according to an embodiment;

FIG. 7 is a schematic drawing illustrating a general scheme of the entropy coder according to an embodiment;

FIG. 8 is a schematic drawing illustrating a general scheme of usage entropy coding in autoencoder-based coders according to an embodiment;

FIG. 9 is a schematic drawing illustrating a general scheme of autoencoder-based coder with entropy coder and gain unit according to an embodiment;

FIG. 10 is a schematic drawing illustrating rate-distortion curve with unusual PSNR drop on high rates according to an embodiment;

FIG. 11 is a schematic drawing illustrating splitting the β range into the intervals;

FIG. 12 is a schematic drawing illustrating a decoding method according to an embodiment;

FIG. 13 is a schematic drawing illustrating a decoding method according to an embodiment;

FIG. 14 is a schematic drawing illustrating an encoding method according to an embodiment;

FIG. 15 is a schematic drawing illustrating an exemplary method for determining the size of the alphabet of the entropy encoder according to an embodiment;

FIG. 16 is a schematic drawing illustrating an exemplary method for determining the size of the alphabet of the entropy encoder according to an embodiment;

FIG. 17 is a schematic drawing illustrating an exemplary method for determining the size of the alphabet of the entropy encoder according to an embodiment;

FIG. 18 is a schematic drawing illustrating an encoding method according to an embodiment;

FIG. 19 is a schematic drawing illustrating a multi-core encoder encoding channels of input data into substreams and concatenating the substreams into a bitstream according to an embodiment;

FIG. 20 is a schematic drawing illustrating an example encoder that is configured to implement the techniques of the present application according to an embodiment;

FIG. 21 is a schematic drawing illustrating an example of a decoder that is configured to implement the techniques of this present application according to an embodiment;

FIG. 22 is a schematic drawing illustrating an example of coding system configured to implement embodiments of the invention according to an embodiment;

FIG. 23 is a schematic drawing illustrating an example of an encoding apparatus or a decoding apparatus according to an embodiment;

FIG. 24 is a schematic drawing illustrating an example of a coding device according to an embodiment;

FIG. 25 is a schematic drawing illustrating an example of a coding system, or an encoding apparatus or a decoding apparatus according to an embodiment;

FIG. 26 is a schematic drawing illustrating an example structure of a content supply system 3100 which realizes a content delivery service according to an embodiment;

FIG. 27 is a schematic drawing illustrating an example structure of a terminal service according to an embodiment.

### DETALIED DESCRIPTION

In the following description, reference is made to the accompanying figures, which form part of the disclosure, and which show, by way of illustration, specific aspects of embodiments of the invention or specific aspects in which embodiments of the present invention may be used. It is understood that embodiments of the invention may be used in other aspects and comprise structural or logical changes not depicted in the figures. The following detailed description, therefore, is not to be taken in a limiting sense, and the scope of the present invention is defined by the appended claims.

For instance, it is understood that a disclosure in connection with a described method may also hold true for a corresponding device or system configured to perform the method and vice versa. For example, if one or a plurality of specific method steps is described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

In the following, an overview over some of the used technical terms and framework within which the embodiments of the present disclosure may be employed is provided.

Video coding typically refers to the processing of a sequence of pictures, which form the video or video sequence. Instead of the term picture, the terms frame or image may be used as synonyms in the field of video coding. Video coding includes two parts, video encoding and video decoding. Video encoding is performed at the source side, typically including processing (e.g. by compression) the original video pictures to reduce the amount of data required for representing the video pictures (for more efficient storage and/or transmission). Video decoding is performed at the destination side and typically includes the inverse processing compared to the encoder to reconstruct the video pictures. Embodiments referring to “coding” of video pictures (or pictures in general, as will be explained later) shall be understood to relate to both, “encoding” and “decoding” of video pictures. The combination of the encoding part and the decoding part is also referred to as CODEC (Coding and DECoding).

### Artificial Neural Networks

Artificial neural networks (ANN) or connectionist systems are computing systems vaguely inspired by the biological neural networks that constitute animal brains. Such systems “learn” to perform tasks by considering examples, generally without being programmed with task-specific rules. For example, in image recognition, they might learn to identify images that contain cats by analyzing example images that have been manually labeled as “cat” or “no cat” and using the results to identify cats in other images. They do this without any prior knowledge of cats, for example, that they have fur, tails, whiskers and cat-like faces. Instead, they automatically generate identifying characteristics from the examples that they process.

An ANN is based on a collection of connected units or nodes called artificial neurons, which loosely model the neurons in a biological brain. Each connection, like the synapses in a biological brain, can transmit a signal to other neurons. An artificial neuron that receives a signal then processes it and can signal neurons connected to it.

In ANN implementations, the “signal” at a connection is a real number, and the output of each neuron is computed by some non-linear function of the sum of its inputs. The connections are called edges. Neurons and edges typically have a weight that adjusts as learning proceeds. The weight increases or decreases the strength of the signal at a connection. Neurons may have a threshold such that a signal is sent only if the aggregate signal crosses that threshold. Typically, neurons are aggregated into layers. Different layers may perform different transformations on their inputs. Signals travel from the first layer (the input layer), to the last layer (the output layer), possibly after traversing the layers multiple times.

The original goal of the ANN approach was to solve problems in the same way that a human brain would. Over time, attention moved to performing specific tasks, leading to deviations from biology. ANNs have been used on a variety of tasks, including computer vision, speech recognition, machine translation, social network filtering, playing board and video games, medical diagnosis, and even in activities that have traditionally been considered as reserved to humans, like painting.

The name “convolutional neural network” (CNN) indicates that the network employs a mathematical operation called convolution. Convolution is a specialized kind of linear operation. Convolutional networks are neural networks that use convolution in place of a general matrix multiplication in at least one of their layers.

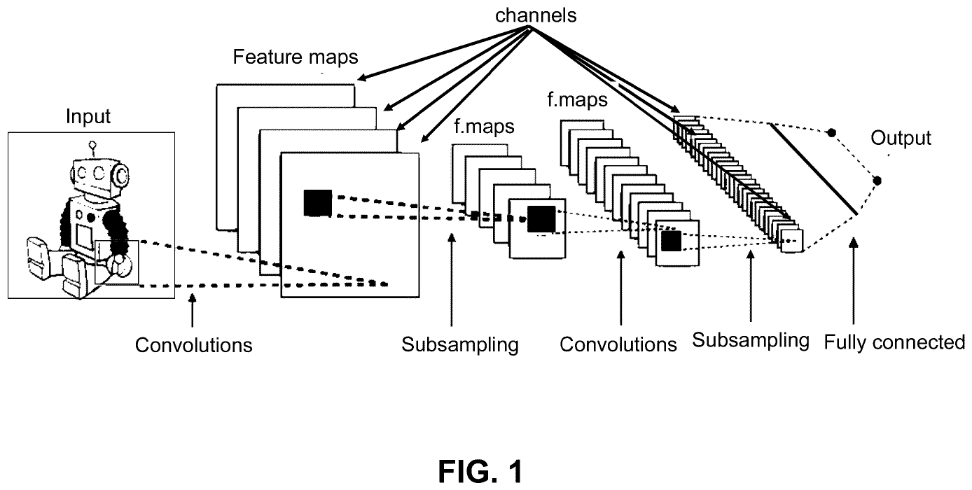

FIG. 1 schematically illustrates a general concept of processing by a neural network such as the CNN. A convolutional neural network consists of an input and an output layer, as well as multiple hidden layers. Input layer is the layer to which the input (such as a portion of an image as shown in FIG. 1) is provided for processing. The hidden layers of a CNN typically consist of a series of convolutional layers that convolve with a multiplication or other dot product. The result of a layer is one or more feature maps (f.maps in FIG. 1), sometimes also referred to as channels. There may be a subsampling involved in some or all of the layers. As a consequence, the feature maps may become smaller, as illustrated in FIG. 1. The activation function in a CNN is usually a ReLU (Rectified Linear Unit) layer, and is subsequently followed by additional convolutions such as pooling layers, fully connected layers and normalization layers, referred to as hidden layers because their inputs and outputs are masked by the activation function and final convolution. Though the layers are colloquially referred to as convolutions, this is only by convention. Mathematically, it is technically a sliding dot product or cross-correlation. This has significance for the indices in the matrix, in that it affects how the weight is determined at a specific index point.

When programming a CNN for processing images, as shown in FIG. 1, the input is a tensor with shape (number of images)×(image width)×(image height)×(image depth). Should be known that image depth can be constitute of channels of image. After passing through a convolutional layer, the image becomes abstracted to a feature map, with shape (number of images)×(feature map width)×(feature map height)×(feature map channels). A convolutional layer within a neural network should have the following attributes. Convolutional kernels defined by a width and height (hyper-parameters). The number of input channels and output channels (hyper-parameter). The depth of the convolution filter (the input channels) should be equal to the number channels (depth) of the input feature map.

The convolutional layer is the core building block of a CNN. The layer's parameters consist of a set of learnable filters (the above-mentioned kernels), which have a small receptive field, but extend through the full depth of the input volume. During the forward pass, each filter is convolved across the width and height of the input volume, computing the dot product between the entries of the filter and the input and producing a 2-dimensional activation map of that filter. As a result, the network learns filters that activate when it detects some specific type of feature at some spatial position in the input.

Another important concept of CNNs is pooling, which is a form of non-linear down-sampling. There are several non-linear functions to implement pooling among which max pooling is the most common. It partitions the input image into a set of non-overlapping rectangles and, for each such sub-region, outputs the maximum. The pooling layer serves to progressively reduce the spatial size of the representation, to reduce the number of parameters, memory footprint and amount of computation in the network, and hence to also control overfitting. It is common to periodically insert a pooling layer between successive convolutional layers in a CNN architecture. The pooling operation provides another form of translation invariance.

The pooling layer operates independently on every depth slice of the input and resizes it spatially. The most common form is a pooling layer with filters of size 2×2 applied with a stride of 2 at every depth slice in the input by 2 along both width and height, discarding 75% of the activations. Due to the aggressive reduction in the size of the representation, there is a recent trend towards using smaller filters or discarding pooling layers altogether. “Region of Interest” pooling (also known as ROI pooling) is a variant of max pooling, in which output size is fixed and input rectangle is a parameter. Pooling is an important component of convolutional neural networks for object detection based on Fast R-CNN architecture.

The above-mentioned ReLU is the abbreviation of rectified linear unit, which applies the non-saturating activation function. It effectively removes negative values from an activation map by setting them to zero. It increases the nonlinear properties of the decision function and of the overall network without affecting the receptive fields of the convolution layer.

After several convolutional and max pooling layers, the high-level reasoning in the neural network is done via fully connected layers. Neurons in a fully connected layer have connections to all activations in the previous layer, as seen in regular (non-convolutional) artificial neural networks. Their activations can thus be computed as an affine transformation, with matrix multiplication followed by a bias offset (vector addition of a learned or fixed bias term).

The “loss layer” (including calculating of a loss function) specifies how training penalizes the deviation between the predicted (output) and true labels and is normally the final layer of a neural network. Various loss functions appropriate for different tasks may be used. Softmax loss is used for predicting a single class of K mutually exclusive classes. Sigmoid cross-entropy loss is used for predicting K independent probability values in [0, 1]. Euclidean loss is used for regressing to real-valued labels.

In summary, FIG. 1 shows the data flow in a typical convolutional neural network. First, the input image is passed through convolutional layers and becomes abstracted to a feature map including several channels, corresponding to a number of filters in a set of learnable filters of this layer. Then, the feature map is subsampled using e.g. a pooling layer, which reduces the dimension of each channel in the feature map. Next, the data comes to another convolutional layer, which may have different numbers of output channels. As was mentioned above, the number of input channels and output channels are hyper-parameters of the layer. To establish connectivity of the network, those parameters need to be synchronized between two connected layers, such that the number of input channels for the current layers should be equal to the number of output channels of the previous layer. For the first layer which processes input data, e.g. an image, the number of input channels is normally equal to the number of channels of data representation, for instance 3 channels for RGB or YUV representation of images or video, or 1 channel for grayscale image or video representation.

### Autoencoders and Unsupervised Learning

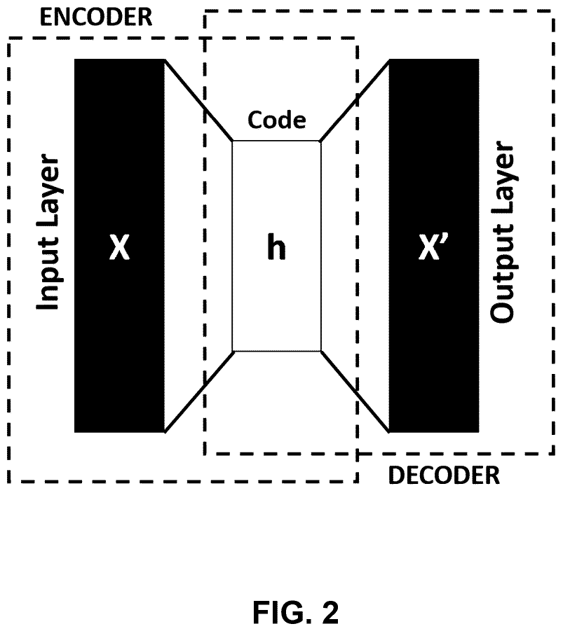

An autoencoder is a type of artificial neural network used to learn efficient data coding in an unsupervised manner. A schematic drawing thereof is shown in FIG. 2. The aim of an autoencoder is to learn a representation (encoding) for a set of data, typically for dimensionality reduction, by training the network to ignore signal “noise”. Along with the reduction side, a reconstructing side is learnt, where the autoencoder tries to generate from the reduced encoding a representation as close as possible to its original input, hence its name. In the simplest case, given one hidden layer, the encoder stage of an autoencoder takes the input x and maps it to h

h=σ(Wx+b).

This image h is usually referred to as code, latent variables, or latent representation. Here, σ is an element-wise activation function such as a sigmoid function or a rectified linear unit. W is a weight matrix b is a bias vector. Weights and biases are usually initialized randomly, and then updated iteratively during training through Backpropagation. After that, the decoder stage of the autoencoder maps h to the reconstruction x′ of the same shape as x:

x′=σ′(W′h′+b′)

where σ′, W′ and b′ for the decoder may be unrelated to the corresponding σ, W and b for the encoder.

Recent progress in artificial neural networks area and especially in convolutional neural networks enables researchers' interest of applying neural networks based technologies to the task of image and video compression. For example, End-to-end Optimized Image Compression has been proposed, which uses a network based on a variational autoencoder.

Accordingly, data compression is considered as a fundamental and well-studied problem in engineering, and is commonly formulated with the goal of designing codes for a given discrete data ensemble with minimal entropy. The solution relies heavily on knowledge of the probabilistic structure of the data, and thus the problem is closely related to probabilistic source modeling. However, since all practical codes must have finite entropy, continuous-valued data (such as vectors of image pixel intensities) must be quantized to a finite set of discrete values, which introduces an error.

In this context, known as the lossy compression problem, one must trade off two competing costs: the entropy of the discretized representation (rate) and the error arising from the quantization (distortion). Different compression applications, such as data storage or transmission over limited-capacity channels, demand different rate-distortion trade-offs.

For example, JPEG uses a discrete cosine transform on blocks of pixels, and JPEG 2000 uses a multi-scale orthogonal wavelet decomposition. Typically, the three components of transform coding methods—transform, quantizer, and entropy code—are separately optimized (often through manual parameter adjustment). Modern video compression standards like HEVC, VVC and EVC also use transformed representation to code residual signal after prediction. The several transforms are used for that purpose such as discrete cosine and sine transforms (DCT, DST), as well as low frequency non-separable manually optimized transforms (LFNST).

### Variational Image Compression

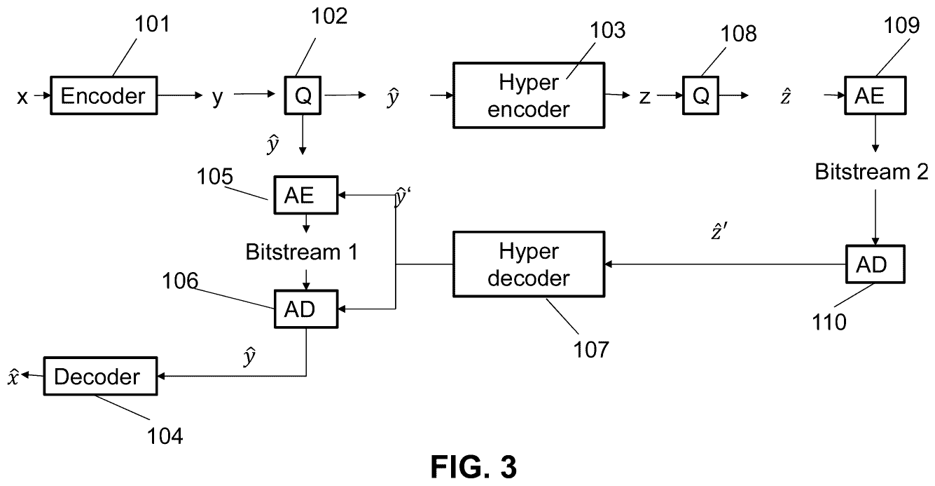

Variable Auto-Encoder (VAE) framework can be considered as a nonlinear transforming coding model. This is exemplified in FIG. 3 showing a VAE framework: the encoder 101 maps an input image x into a latent representation (denoted by y) via the function y=f(x). This latent representation may also be referred to as a part of or a point within a “latent space” in the following. The function ƒ( ) is a transformation function that converts the input signal x into a more compressible representation y. The quantizer 102 transforms the latent representation y into the quantized latent representation ŷ with (discrete) values by ŷ=Q(y), with Q representing the quantizer function. The entropy model, or the hyper encoder/decoder (also known as hyperprior) 103 estimates the distribution of the quantized latent representation y to get the minimum rate achievable with a lossless entropy source coding.

The latent space can be understood as a representation of compressed data in which similar data points are closer together in the latent space. Latent space is useful for learning data features and for finding simpler representations of data for analysis. The quantized latent representation T, ŷ and the side information \hat{z} of the hyperprior 3 are included into a bitstream 2 (are binarized) using arithmetic coding (AE). Furthermore, a decoder 104 is provided that transforms the quantized latent representation to the reconstructed image \hat{x}, \hat{x}=g(ŷ). The signal \hat{x} is the estimation of the input image x. It is desirable that x is as close to \hat{x} as possible, in other words the reconstruction quality is as high as possible. However, the higher the similarity between \hat{x} and x, the higher the amount of side information necessary to be transmitted. The side information includes bitstream1 and bitstream2 shown in FIG. 3, which are generated by the encoder and transmitted to the decoder. Normally, the higher the amount of side information, the higher the reconstruction quality. However, a high amount of side information means that the compression ratio is low. Therefore, one purpose of the system described in FIG. 3 is to balance the reconstruction quality and the amount of side information conveyed in the bitstream.

In FIG. 3 the component AE 105 is the Arithmetic Encoding module, which converts samples of the quantized latent representation ŷ and the side information 2 into a binary representation bitstream 1. The samples of ŷ and \hat{z} might for example comprise integer or floating point numbers. One purpose of the arithmetic encoding module is to convert (via the process of binarization) the sample values into a string of binary digits (which is then included in the bitstream that may comprise further portions corresponding to the encoded image or further side information).

The arithmetic decoding (AD) 106 is the process of reverting the binarization process, where binary digits are converted back to sample values. The arithmetic decoding is provided by the arithmetic decoding module 106.

It is noted that the present disclosure is not limited to this particular framework. Moreover, the present disclosure is not restricted to image or video compression, and can be applied to object detection, image generation, and recognition systems as well.

In FIG. 3 there are two sub networks concatenated to each other. A subnetwork in this context is a logical division between the parts of the total network. For example, in FIG. 3 the modules 101, 102, 104, 105 and 106 are called the “Encoder/Decoder” subnetwork. The “Encoder/Decoder” subnetwork is responsible for encoding (generating) and decoding (parsing) of the first bitstream “bitstream1”. The second network in FIG. 3 includes modules 103, 108, 109, 110 and 107 and is called “hyper encoder/decoder” subnetwork. The second subnetwork is responsible for generating the second bitstream “bitstream2”.

The first subnetwork is responsible for:
the transformation 101 of the input image x into its latent representation y (which is easier to compress that x),
quantizing 102 the latent representation y into a quantized latent representation ŷ,
compressing the quantized latent representation ŷ using the AE by the arithmetic encoding module 105 to obtain bitstream “bitstream 1”,”.
parsing the bitstream 1 via AD using the arithmetic decoding module 106, and
reconstructing 104 the reconstructed image (\hat{x}) using the parsed data.

The purpose of the second subnetwork is to obtain statistical properties (e.g. mean value, variance and correlations between samples of bitstream 1) of the samples of “bitstream1”, such that the compressing of bitstream 1 by first subnetwork is more efficient. The second subnetwork generates a second bitstream “bitstream2”, which includes the said information (e.g. mean value, variance and correlations between samples of bitstream1).

The second network includes an encoding part which includes transforming 103 of the quantized latent representation ŷ into side information z, quantizing the side information z into quantized side information \hat{z}, and encoding (e.g. binarizing) 109 the quantized side information \hat{z} into bitstream2. In this example, the binarization is performed by an arithmetic encoding (AE). A decoding part of the second network includes arithmetic decoding (AD) 110, which transforms the input bitstream2 into decoded quantized side information \hat{z}′. The \hat{z}′ might be identical to \hat{z}, since the arithmetic encoding and decoding operations are lossless compression methods. The decoded quantized side information \hat{z}′ is then transformed 107 into decoded side information ŷ′. ŷ′ represents the statistical properties of ŷ (e.g. mean value of samples of ŷ, or the variance of sample values or like). The decoded latent representation ŷ′ is then provided to the above-mentioned Arithmetic Encoder 105 and Arithmetic Decoder 106 to control the probability model of ŷ.

The FIG. 3 describes an example of VAE (variational auto encoder), details of which might be different in different implementations.

A majority of Deep Learning (DL) based image/video compression systems reduce dimensionality of the signal before converting the signal into binary digits (bits). In the VAE framework for example, the encoder, which is a non-linear transform, maps the input image x into y, where y has a smaller width and height than x. Since the y has a smaller width and height, hence a smaller size, the (size of the) dimension of the signal is reduced, and, hence, it is easier to compress the signal y. It is noted that in general, the encoder does not necessarily need to reduce the size in both (or in general all) dimensions. Rather, some exemplary implementations may provide an encoder which reduces size only in one (or in general a subset of) dimension.

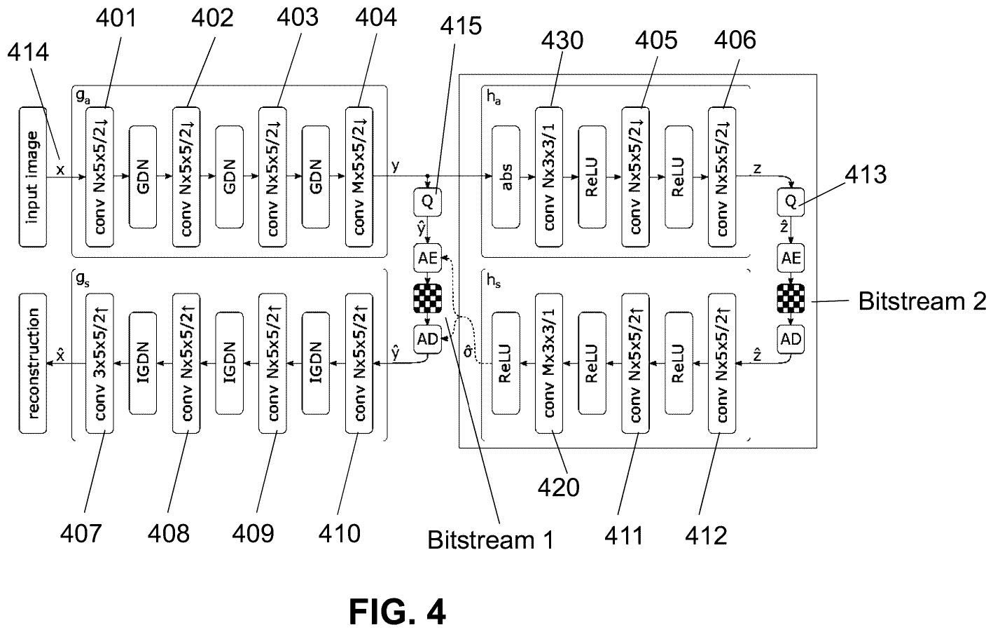

Such example of the VAE framework is shown in FIG. 4, and it utilizes 6 downsampling layers that are marked with 401 to 406. The network architecture includes a hyperprior model. The left side (gₐ, gₛ) shows an image autoencoder architecture, the right side (hₐ, hₛ) corresponds to the autoencoder implementing the hyperprior. The factorized-prior model uses the identical architecture for the analysis and synthesis transforms gₐ and gₛ. Q represents quantization, and AE, AD represent arithmetic encoder and arithmetic decoder, respectively. The encoder subjects the input image x to gₐ, yielding the responses y (latent representation) with spatially varying standard deviations. The encoding gₐ includes a plurality of convolution layers with subsampling and, as an activation function, generalized divisive normalization (GDN).

The responses are fed into hₐ, summarizing the distribution of standard deviations in z. z is then quantized, compressed, and transmitted as side information. The encoder then uses the quantized vector \hat{z} to estimate \hat{σ}, the spatial distribution of standard deviations which is used for obtaining probability values (or frequency values) for arithmetic coding (AE), and uses it to compress and transmit the quantized image representation ŷ (or latent representation). The decoder first recovers \hat{z} from the compressed signal. It then uses hₛ to obtain ŷ, which provides it with the correct probability estimates to successfully recover ŷ as well. It then feeds ŷ into gₛ to obtain the reconstructed image.

The layers that include downsampling is indicated with the downward arrow in the layer description. The layer description “Conv N×5×5/2↓” means that the layer is a convolution layer, with N channels and the convolution kernel is 5×5 in size. As stated, the 2↓means that a downsampling with a factor of 2 is performed in this layer. Downsampling by a factor of 2 results in one of the dimensions of the input signal being reduced by half at the output. In FIG. 4, the 2↓indicates that both width and height of the input image is reduced by a factor of 2. Since there are 6 downsampling layers, if the width and height of the input image 414 (also denoted with x) is given by w and h, the output signal \hat{z} 413 has width and height equal to w/64 and h/64 respectively. Modules denoted by AE and AD are arithmetic encoder and arithmetic decoder, which are explained with reference to FIG. 3. The arithmetic encoder and decoder are specific implementations of entropy coding. AE and AD can be replaced by other means of entropy coding. In information theory, an entropy encoding is a lossless data compression scheme that is used to convert the values of a symbol into a binary representation which is a revertible process. Also, the “Q” in the figure corresponds to the quantization operation, the quantization operation and a corresponding quantization unit as part of the component 413 or 415 is not necessarily present and/or can be replaced with another unit.

### Cloud Solutions for Machine Tasks

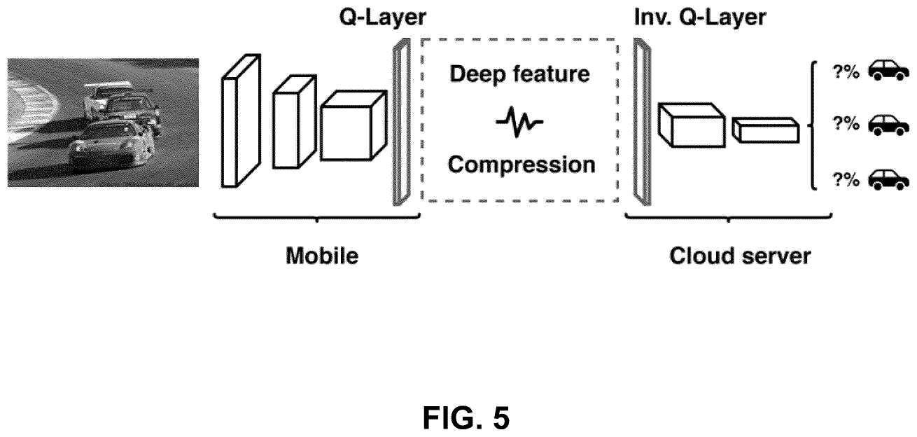

The Video Coding for Machines (VCM) is another computer science direction being popular nowadays. The main idea behind this approach is to transmit the coded representation of image or video information targeted to further processing by computer vision (CV) algorithms, like object segmentation, detection and recognition. In contrast to traditional image and video coding targeted to human perception the quality characteristic is the performance of computer vision task, e.g. object detection accuracy, rather than reconstructed quality. This is illustrated in FIG. 5.

Video Coding for Machines is also referred to as collaborative intelligence and it is a relatively new paradigm for efficient deployment of deep neural networks across the mobile-cloud infrastructure. By dividing the network between the mobile and the cloud, it is possible to distribute the computational workload such that the overall energy and/or latency of the system is minimized. In general, the collaborative intelligence is a paradigm where processing of a neural network is distributed between two or more different computation nodes; for example devices, but in general, any functionally defined nodes. Here, the term “node” does not refer to the above-mentioned neural network nodes. Rather the (computation) nodes here refer to (physically or at least logically) separate devices/modules, which implement parts of the neural network. Such devices may be different servers, different end user devices, different intelligent vehicles or vehicle-mounted devices, a mixture of servers and/or user devices and/or cloud and/or processor or the like. In other words, the computation nodes may be considered as nodes belonging to the same neural network and communicating with each other to convey coded data within/for the neural network. For example, in order to be able to perform complex computations, one or more layers may be executed on a first device and one or more layers may be executed in another device. However, the distribution may also be finer and a single layer may be executed on a plurality of devices. In this disclosure, the term “plurality” refers to two or more. In some existing solution, a part of a neural network functionality is executed in a device (user device or edge device or the like) or a plurality of such devices and then the output (feature map) is passed to a cloud. A cloud is a collection of processing or computing systems that are located outside the device, which is operating the part of the neural network. The notion of collaborative intelligence has been extended to model training as well. In this case, data flows both ways: from the cloud to the mobile during back-propagation in training, and from the mobile to the cloud during forward passes in training, as well as inference.

Some works presented semantic image compression by encoding deep features and then reconstructing the input image from them. The compression based on uniform quantization was shown, followed by context-based adaptive arithmetic coding (CABAC) from H.264. In some scenarios, it may be more efficient, to transmit from the mobile part to the cloud an output of a hidden layer (a deep feature map), rather than sending compressed natural image data to the cloud and perform the object detection using reconstructed images. The efficient compression of feature maps benefits the image and video compression and reconstruction both for human perception and for machine vision. Entropy coding methods, e.g. arithmetic coding is a popular approach to compression of deep features (i.e. feature maps).

Nowadays, video content contributes to more than 80% internet traffic, and the percentage is expected to increase even further. Therefore, it is critical to build an efficient video compression system and generate higher quality frames at given bandwidth budget. In addition, most video related computer vision tasks such as video object detection or video object tracking are sensitive to the quality of compressed videos, and efficient video compression may bring benefits for other computer vision tasks. Meanwhile, the techniques in video compression are also helpful for action recognition and model compression.

### End-to-End Image or Video Compression

DNN based image compression methods can exploit large scale end-to-end training and highly non-linear transform, which are not used in the traditional approaches. However, it is non-trivial to directly apply these techniques to build an end-to-end learning system for video compression. First, it remains an open problem to learn how to generate and compress the motion information tailored for video compression. Video compression methods heavily rely on motion information to reduce temporal redundancy in video sequences.

A straightforward solution is to use the learning based optical flow to represent motion information. However, current learning based optical flow approaches aim at generating flow fields as accurate as possible. The precise optical flow is often not optimal for a particular video task. In addition, the data volume of optical flow increases significantly when compared with motion information in the traditional compression systems and directly applying the existing compression approaches to compress optical flow values will significantly increase the number of bits required for storing motion information. Second, it is unclear how to build a DNN based video compression system by minimizing the rate-distortion based objective for both residual and motion information. Rate-distortion optimization (RDO) aims at achieving higher quality of reconstructed frame (i.e., less distortion) when the number of bits (or bit rate) for compression is given. RDO is important for video compression performance. In order to exploit the power of end-to-end training for learning based compression system, the RDO strategy is required to optimize the whole system.

In Guo Lu, Wanli Ouyang, Dong Xu, Xiaoyun Zhang, Chunlei Cai, Zhiyong Gao; “DVC: An End-to-end Deep Video Compression Framework”. Proceedings of the IEEE/CVF Conference on Computer Vision and Pattern Recognition (CVPR), 2019, pp. 11006-11015, authors proposed the end-to-end deep video compression (DVC) model that jointly learns motion estimation, motion compression, and residual coding.

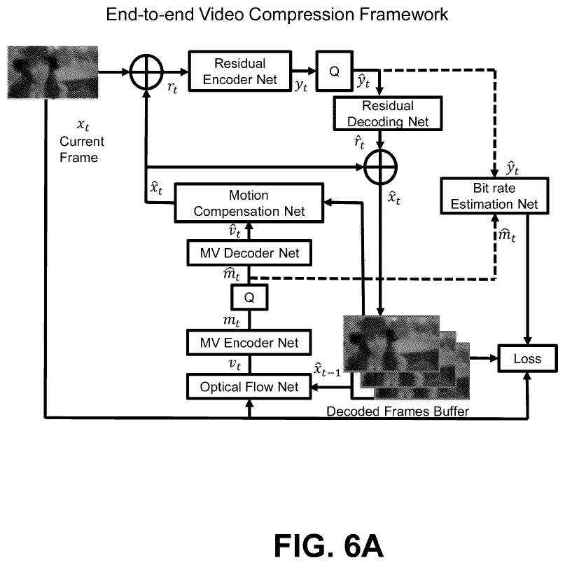

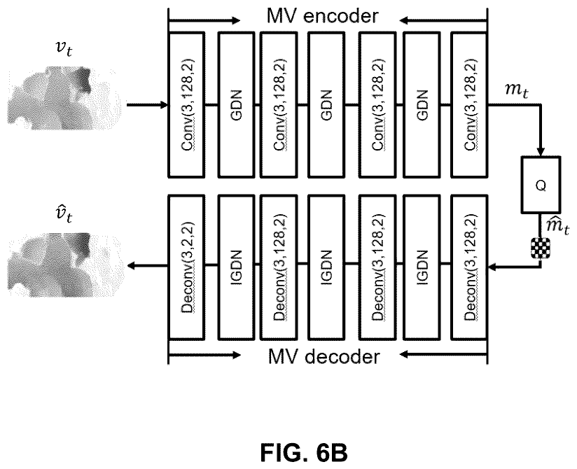

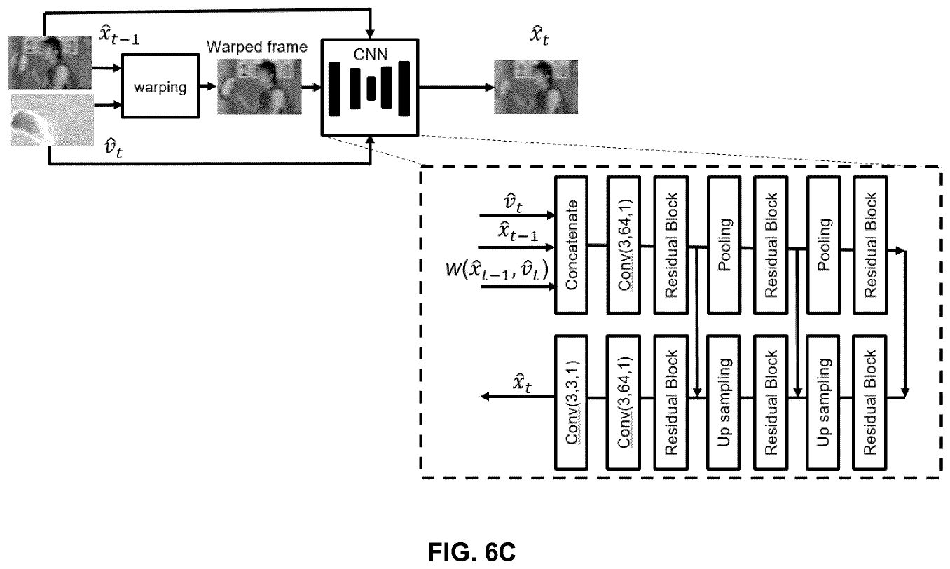

Such encoder is illustrated in FIG. 6A. In particular, FIG. 6A shows an overall structure of end-to-end trainable video compression framework. In order to compress motion information, a CNN was designated to transform the optical flow to the corresponding representations suitable for better compression. Specifically, an auto-encoder style network is used to compress the optical flow. The motion vectors (MV) compression network is shown in FIG. 6B. The network architecture is somewhat similar to the gₐ/gₛ of FIG. 4. In particular, the optical flow is fed into a series of convolution operation and nonlinear transform including GDN and IGDN. The number of output channels for convolution (deconvolution) is 128 except for the last deconvolution layer, which is equal to 2. Given optical flow with the size of M×N×2, the MV encoder will generate the motion representation with the size of M/16×N/16×128. Then motion representation is quantized, entropy coded and sent to bitstream. The MV decoder receives the quantized representation and reconstruct motion information using MV encoder.

FIG. 6C shows a structure of the motion compensation part. Here, using previous reconstructed frame xₜ₋₁ and reconstructed motion information, the warping unit generates the warped frame (normally, with help of interpolation filter such as bi-linear interpolation filter). Then a separate CNN with three inputs generates the predicted picture. The architecture of the motion compensation CNN is also shown in FIG. 6C.

The residual information between the original frame and the predicted frame is encoded by the residual encoder network. A highly non-linear neural network is used to transform the residuals to the corresponding latent representation. Compared with discrete cosine transform in the traditional video compression system, this approach can better exploit the power of non-linear transform and achieve higher compression efficiency.

From above overview it can be seen that CNN based architecture can be applied both for image and video compression, considering different parts of video framework including motion estimation, motion compensation and residual coding. Entropy coding is popular method used for data compression, which is widely adopted by the industry and is also applicable for feature map compression either for human perception or for computer vision tasks.

In case of lossless video coding, the reconstructed video pictures have the same quality as the original video pictures (assuming no transmission errors or other data loss during storage or transmission). In case of lossy video coding, further compression, e.g. by quantization, is performed, to reduce the amount of data representing the video pictures, which cannot be completely reconstructed at the decoder, i.e. the quality of the reconstructed video pictures is lower or worse compared to the quality of the original video pictures.

### Arithmetic Encoding

Entropy coding is typically employed as a lossless coding. Arithmetic coding is a class of entropy coding, which encodes a message as a binary real number within an interval (a range) that represents the message. Herein, the term message refers to a sequence of symbols. Symbols are selected out of a predefined alphabet of symbols. For example, an alphabet may consist of two values 0 and 1. A message using such alphabet is then a sequence of bits. The symbols (0 and 1) may occur in the message with mutually different frequency. In other words, the symbol probability may be non-uniform. In fact, the less uniform the distribution, the higher is the achievable compression by an entropy code in general and arithmetic code in particular. Arithmetic coding makes use of an a priori known probability model specifying the symbol probability for each symbol of the alphabet. An alphabet does not need to be binary. Rather, the alphabet may consist e.g. of M values 0 to M−1. In general, any alphabet with any size may be used. Typically, the alphabet is given by the value range of the coded data.

A variation of the arithmetic coder improved for a practical use is referred to as a range coder, which does not use the interval [0,1), but a finite range of integers, e.g. from 0 to 255. This range is split according to probabilities of the alphabet symbols. The range may be renormalized if the remaining range becomes too small in order to describe all alphabet symbols according to their probabilities.

One of the main types of entropy coders assigns a unique code to each unique symbol that occurs in the input. These entropy encoders compress data by replacing each fixed-length input symbol with the corresponding variable-length output codeword. For the data streams with some specific entropy characteristics a simple static code may be useful. These static codes include universal codes (such as Elias gamma coding or Fibonacci coding) and Golomb codes (such as unary coding or Rice coding). For the general data streams the code can be constructed based on the following rule: the length of each codeword is approximately proportional to the negative logarithm of the probability of occurrence of that codeword. Therefore, the most common symbols use the shortest codes. Based on the constructed code table, coder compress data by replacing each fixed-length input symbol with the corresponding variable-length prefix-free output codeword. An example of such coding is Huffman coding. The main problem of such a coding is that at least one bit is needed for each input symbol even if the probability of it is close to 1. As a speedup of arithmetic coders, asymmetric numeral systems (ANS) family of entropy coding techniques were invented. Such coders provides combination of the compression ratio of arithmetic coding with a processing cost similar to Huffman coding.

An entropy coder encodes symbols of input alphabet A, having size M, to symbols of alphabet B, having size R, by using an amount of output symbols inversely proportional to the probability of the coded symbols. Usually, probability pᵢ of the symbol aᵢ from the alphabet A means probability of appearance of symbol aᵢ in the arbitrary sequence of symbols from the alphabet A. In other words, probability pᵢ means probability of the event that a received symbol y is equal to aᵢ. Unequal probabilities of different symbols from the alphabet give the potential for compression. If all symbols in the alphabet have the same probabilities pi=1/M, where M is the size of the alphabet A than compression is impossible.

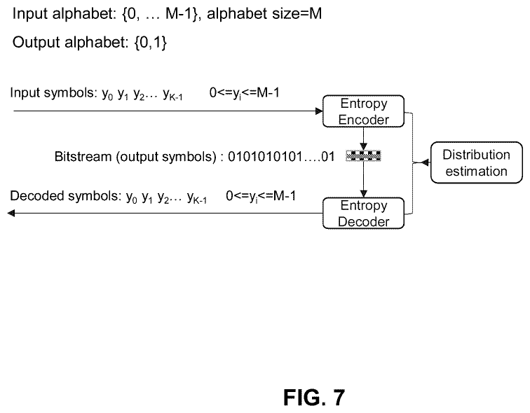

General scheme of the entropy coder is depicted on FIG. 7. In most cases, the output alphabet is {0,1}, and size of the output alphabet is usually equal to 2, the symbols of output binary alphabet are called bits and the sequence of the bits corresponding to the sequence of coded symbols from the input alphabet is called bitstream. As can be seen in FIG. 7, the output symbols of the entropy encoder called bitstream, is the input for the entropy decoder. The output for the entropy decoder is in the same alphabet as the input of the entropy encoder. And the output for the entropy decoder can be called decoded symbols. Besides, alphabet means a set of the symbols, alphabet size means the number of symbols in the input alphabet. Here input symbols are denoted as 0,1, 2, . . . , M−1, so there are M different symbols in total in the input alphabet. It has to be noted that in this application, alphabet size M always means the size of the input alphabet.

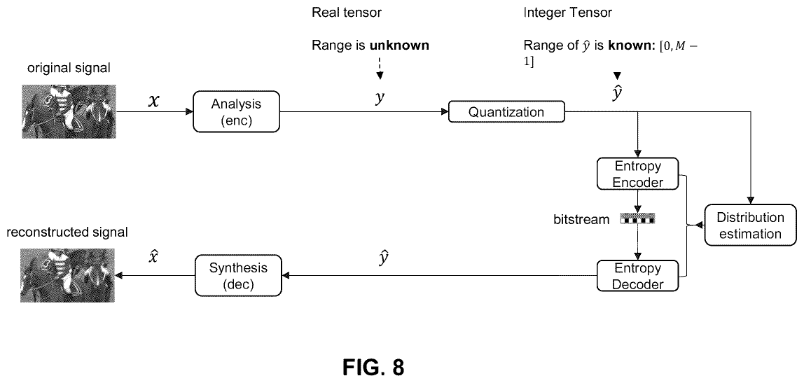

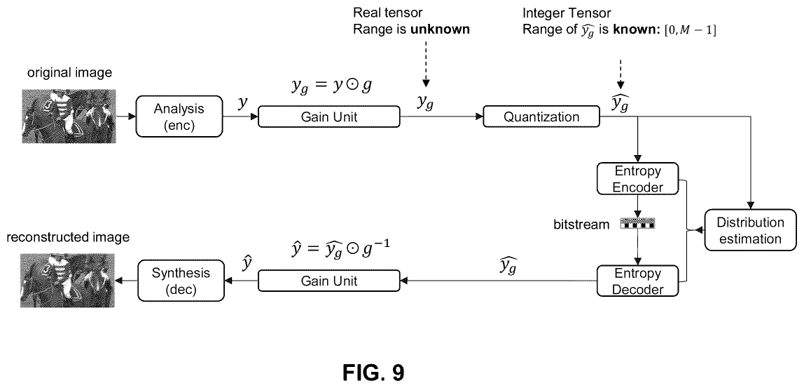

In autoencoder-based coding schemes, entropy coder is used to compress latent space symbols. Distribution estimation can be done in advance (pre-trained histograms) or can be performed using some extra information from the bitstreams and/or information from neighboring latents. A general scheme of usage entropy coding in autoencoder-based coders is depicted on FIG. 8: input signal x is converted to feature (or latent) tensor y, “x” here means input signal corresponding to the image data, “y” here means latent space tensor, the convertion processing here can be called as feature extraction, and the latent space tensor includes latent space elements, the latent space elements will be quantized and put as input to the entropy encoder. In some possible embodiments, the latent space elements will be processed by a gain unit as shown in FIG. 9, then be quantized, and then put as input to the entropy encoder. Tensor y comprise real (not integer) numbers (e.g. floating point values) and range of these numbers is not known in advance. Entropy coder can work only with finite input alphabet, so tensor y is converted to the integer tensor y including values from 0 to M−1, where M is the alphabet size of the entropy coder. Such conversion from continuous set of values to the discrete set is called quantization. The conversion can comprise clamping, rounding and scaling operations. In one exemplary implementation, y can be firstly clamped to range

$$[ - \frac{M}{2} , \frac{M}{2} - 1 ] ,$$

then rounded, then with adding M/2 the resulting tensor ŷ is converted to range [0, M−1]. As far as real tensor y is converted to integer tensor ŷ, with all values laying within the range [0,M−1], data of tensor ŷ can be encoded by the entropy coder to the bitstream. On the decoder side the entropy decoder decodes tensor ŷ from the bitstream, which is further transformed to the reconstructed signal \hat{x} with the synthesis part of the autoencoder. It's important to mention, that same parameters of the entropy coder, in particular, a same input alphabet size is used for all possible input signals {x}. So, it could be said that the entropy coding parameters are predefined in conventional method.

As shown in FIG. 9, to control the quantization error and the bitstream size (bitrate), gain unit can be added to the coding scheme. It has to be noted here that, with bigger bitrate, the data can be compressed with better quality, while with lower bitrate, the data can be compressed with lower quality. The process of adjusting compression system parameters to achieve desired ratio between the bitrate and quality (or achieve the desired bitrate) is called rate control. The parameter used during rate control is called rate control parameter β. A gain unit is used for the rate control. The gain unit is a part on Neural Network which performs multiplying of the latent space tensor y to the gain vector g: y⊙g, where iₜₕ channel of the tensor y is multiplied to element g[i] of the vector g. The size of vector g is equal to the number of channels in the latent tensor y, so every channel is multiplied to its own scaling factor g[i]. If lower bitrate is needed, than smaller gain vector g is selected, and if higher bitrate is needed, bigger vector g is used. In this case before the quantization, latent tensor y is multiplied to the gain vector g to obtain the real tensor y_{g}. Usually, for higher bitrate, vector g including greater values is selected, and the range of y_{g} became much wider than the range of y, in such case, a predefined alphabet size M, selected once based on the expected y values, became not suitable for such y_{g} values. Clipping of y_{g} based on alphabet size M cause to significant signal corruption, which cause bad reconstruction quality. In some exemplary implementation bitrate can be controlled by scalar parameter β, the scalar parameter β can also be called as rate control parameter β, and there is a predefined scheme or pre-trained function g(β) of obtaining gain vector g for each value B. Usually greater values β results in higher bitrate. And for high bitrate, y_{g} can have much bigger range than the original values of y. In one possible embodiment, for the systems without gain unit, the rate control parameter beta can be specified during the model training as a rate-distortion weighting factor in loss function. E.g. loss function can be as following: loss=β*distortion+number_of_bits, where β means the rate control parameter, number_of_bits is number of spent bits or bits per pixel (bpp). In this case, the model is trained for one specific ratio between the distortion and the bitrate (one rate point)

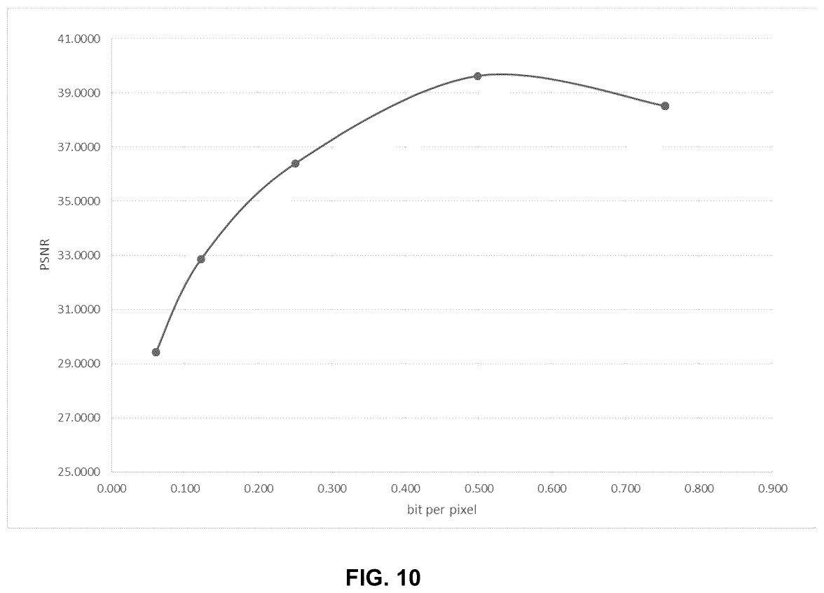

FIG. 10 shows rate-distortion curve for one of autoencoder-based coders with gain unit. The horizontal axis indicates the bitrate in bit per pixel (bpp), and the vertical axis indicates the Peak signal-to-noise ratio (PSNR), As could be noticed here, that with increasing the bitrate (horizontal axis) higher than 0.5 bpp, the PSNR of the reconstructed signal (vertical axis) is not increased, but vice versa-goes down. It happens due to critically big y_{g} clipping error for high bitrate.

One possible solution is selecting extremely large alphabet size and using it for all cases, but increasing the alphabet size penalizes compression efficiency under some conditions, such as big alphabet size is not needed for low bitrates, usage of big alphabet size can increase the bitrate significantly but will not improve reconstruction quality.

In the conventional methods, the entropy coding parameters are usually predefined, for example, an alphabet size M is usually predefined by selecting once based on expected tensor range (or latent tensor range) and using the predefined alphabet size M for all cases. In such case, if the real tensor range is wider than the expected tensor range, the input alphabet size determined based on the expected tensor range will not be suitable, then clipping is needed for coded tensor values. Such a clipping corrupts the signal, especially if coded tensor range differs a lot from the alphabet size. Corruption of the coded tensor in this case is non-linear distortion which cause unpredictable errors in reconstruction signal, so the quality of the reconstructed signal can suffer quite significantly. In one implementation, extremely large alphabet size can be selected and can be used for all cases, but increasing the alphabet size penalizes compression efficiency for low bitrate conditions, usage of big alphabet size will result in bitrate increasing significantly but will not improve reconstruction quality.

To solve the abovementioned problem, the embodiment of this application proposes content/bitrate adaptive entropy coding parameters selection, in particular the entropy coding parameters can be the input alphabet size, thus clipping effect can be avoided on high rates without the rate overhead caused by unreasonably big alphabet size for the low rates. Due to adaptiveness of the entropy coding parameters, in particular the alphabet size, the optimal work of the entropy coder is possible on low rates (narrow range of the coded values) which results in the bitrate saving; and the absence of clipping effect is achieved on high rates (wide range of coded values), which results in higher reconstruction signal quality.

The basic idea of the solution is bitrate/content adaptiveness of the entropy coding parameters, in particular the alphabet size. For proper work of the entropy coding all parameters should be aligned between the encoder and the decoder, so basically two problems need to be solved:
1. How to select proper alphabet size on the encoder side?
2. How to derive the alphabet size (selected on encoder side) on the decoder side?

For alphabet selection on encoder-side, several possible solutions are proposed.

In one embodiment, the alphabet size can be selected as the minimal possible number higher than the coded values range. For example, minimum and maximum values for tensor y are obtained first and alphabet size is selected as:

M=ceil(max{y}−min{y}),

where ceil(x) is the smallest integer number higher than x. For most of the entropy coders the alphabet size should be the power of 2, the alphabet size in this case can be selected as M=2\hat{ }(ceil(log₂(max{y}−min{y}))). Where, {y} means latent space elements in the latent space, where the latent space elements are result of procession of the input signals. Sometimes, the processing for transforming input signals to latent space tensor y, is called feature extraction. Generally, the input signal, such as input image, is converted to latent space (feature space), and the latent space elements are quantized and then encoded with the entropy encoder. Also the latent space can be additionally processed (e.g. multiplied to the gain vector) before the quantization. It should be noticed that there are some cases, e.g. when module of all y values is smaller than 1, the additional scaling operation can be performed before the entropy coding.

In another embodiment, the alphabet size can be selected based on rate-distortion optimization process. Firstly, a few values of M around M_0=ceil(max{y}−min{y}) are tried and then loss function is calculated for all these values. Alphabet size M_i for which the loss function is minimal is selected. The loss function might include rate and distortion components, such as PSNR, Multi-Scale Structural Similarity index (MS-SSIM), Video Multimethod Assessment Fusion (VMAF) or some other quality metric. Within this approach clipping can occurs sometimes, but the bitrate saving due to usage of smaller alphabet compensate minor distortion increase. For example, the loss function can be: loss=beta*distortion+bits, where the distortion is measured with PSNR or MS-SSIM or VMAF, bits is number of spent bits, and beta is a weighting parameter which controls the ratio between the bitrate and the reconstruction quality, and beta can also be called as rate control parameter.

For alphabet size derivation on decoder-side, several possible solutions are proposed.

### EMBODIMENT 1

In one embodiment, the alphabet size can be signaled in the bitstream explicitly. In one embodiment, the alphabet size can be signaled directly in the bitstream, e.g. with fixed-length coding, exp-Golomb coding, or some other coding algorithm. Typical values of M can be 256, 512, 1024, for example, for signaling 1024 with, e.g. fixed-length code, 11 bits is needed (1024₁₀=10000000000₂) and for signaling log₂(1024)−9=1, that is only 1 bit is needed if only values 512 and 1024 are allowed, or 2 bits are needed if 4 different alphabet sizes like 512, 1024, 2048, 4096 are allowed. As a result, direct signaling of M will cost more bits. But for some exotic cases (e.g. alphabet size M is not the power of two) direct signaling of M can be helpful.

In an alternative embodiment, an output p of some reversible function ƒ(M) instead of M itself can be signaled in the bitstream, the output p can be referred to as first indication information. Such p can be signaled with fixed-length coding, exp-Golomb coding, or some other coding algorithm. Accordingly, on decoder side M is derived based on the first indication information, specifically, M is derived as M=f⁻¹(p). Examples of such reversible function ƒ(M) can be as follows:
1. ƒ(M)=logₖ(M), where k is natural number, for example k can be equal to 2;
2. ƒ(M)=logₖ(M)−C, where C is integer number which is used as a predictor, for example, C can be equal to 9;
3. ƒ(M)=M+R, where R is integer number which is used as a predictor;
4. ƒ(M)=sqrt (M);

The preferable way is signaling of p=f(M)=log₂(M)−9.

In some implementations, p is greater than or equal to 0, but in other implementations it can also be negative. For example, value p can be within the range [0, 5] and 3 bits are used for the signaling. The function ƒ(M) is negotiated between the encoder side and the decoder side in advance.

In one possible embodiment, the alphabet size is signaled e.g. in a parameter set section in the bitstream, e.g. in a Picture Parameter Set section of the bitstream.

The benefit of the above embodiment 1 is that any optimal alphabet size selected on the encoder-side can be signaled, so the flexibility of signaling the alphabet size is increased. The only disadvantage is that a few bits are spent to the signaling, so the bitstream size slightly increases.

### EMBODIMENT 2

In one possible embodiment, the alphabet size can be derived based on some other parameters. In one exemplary implementation the alphabet size is derived from the quantization parameter or rate control parameter, alternatively the alphabet size can be derived from the image resolution, video resolution, framerate, density of pixels in 3D object and so on. In trainable codecs, the alphabet size can be derived from some parameters of the loss function used during the training, for example weighting factor for rate/distortion, or some parameters which affects gain vector g selection. Also it could be quantization parameter, like quantization parameter (qp) in regular codecs like JPEG, HEVC, VVC. For example, the loss function can be: loss=beta*distortion+bitrate, where beta is a weighting factor.

In one exemplary implementation, denote such a rate control parameter as β, the range of betas(β) is split into K intervals (K sub-ranges) as follows:

[β_0,β_1),[β_1,β_2), . . . ,[β_(K−1),β_K)

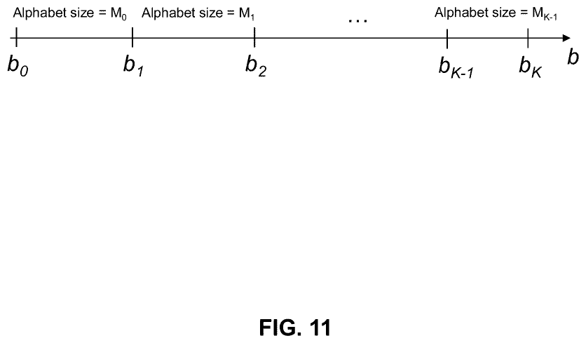

Each one of the intervals/sub-range corresponds to one alphabet size Mi. It should be noticed, that β_0 can be equal to −∞ and β_K can be equal to +∞. There will be a range of allowed for particular codec values β; e.g. for some codecs β can be allowed to be within the range [−∞,∞], for the other codecs β can be allowed to be only within the range [0,∞]. Anyway some big range of allowed β(beta) values exists. Within the context of this embodiment, the original big range of allowed β values is split to a few sub-ranges and for the every sub-range there is a specific value of the alphabet size. One specific splitting of the β values on the intervals is depicted on FIG. 11.

In this case, after obtaining parameter β, the decoder can choose the target interval based on the β value obtained from the bitstream. For specific, the decoder determines that β_i≤β≤β_(i+1), then the interval [β_i,β_(i+1)] is chosen as the target interval, and the alphabet size Mi corresponding to this target interval is derived as the input alphabet size M by the decoder side.

In some embodiments, each βi in the range of betas{βi} can correspond to one alphabet size Mi, and the alphabet size M corresponding to the particular β is calculated based on one or more Mi corresponding to βi neighboring for β. It should be noted that the values used for calculating M could be the just values Mi of the nearest neighbor corresponding to the target interval, or it could be linear or bilinear or some other interpolation from the two or more Mi corresponding to βi neighboring for β, or some other interpolation from the two or more Mi corresponding to the intervals neighboring to the target interval.

The benefit of the above embodiment 2 is that since quantization parameters or rate control parameters that already exist in the bitstream that are used for other procedure can be used by the decoder side to derive the alphabet size M, so there is no need for additional signaling for informaiton specifically used to indicate the alphabet size M, so bitrate can be saved. The disadvantage of the embodiment 2 is absence of flexibility, so if for some reasons derived alphabet size is not optimal, encoder and decoder have to use it despite of the less compression efficiency.

### EMBODIMENT 3

In one embodiment, the alphabet size can be derived based on a predictor P and a second indication information, the second indication information is signaled in the bitstream and is used to indicate the difference between the P and M. And the predictor P can be derived by the decoder based on one of techniques described in the above Embodiment 2, such as, quantization parameters, rate control parameters, parameters of the loss function used during training for trainable codecs, or some parameters which affects gain vector g selection. The parameter used to derive predictor P is selected by the encoder or can be predefined by the standard. Thus, when receives a bitstream, the decoder derives the predictor P based on the predefined parameters, and parses the second indication information from the bitstream, and then the alphabet size M can be derived based on the predictor P and the second indication information.

In one embodiment, the difference between the P and M can be signaled in the bitstream directly, e.g. with fixed-length coding, exp-Golomb coding, or some other coding algorithm. In an alternative embodiment, an output D of some reversible function s(M,P) can be signaled in the bitstream. Such D can be signaled with fixed-length coding, exp-Golomb coding, or some other coding algorithm. In this case, M is derived as M=s⁻¹(D,P) on decoder side. Examples of such reversible function s(M,P) can be as follows:
1. s(M,P)=logₖ(M)−logₖ(P), where k is natural number, for example k can be equal to 2;
2. s(M,P)=logₖ(P)−logₖ(M), where k is natural number, for example k can be equal to 2;
3. s(M,P)=logₖ(M)−logₖ(P)−C, where C is integer number;
4. s(M,P)=logₖ(P)−logₖ(M)−C, where C is integer number;
5. s(M,P)=a*logₖ(P)+b*logₖ(M)−c, where a, b and c are constants;
6. s(M,P)=a*M+b*P+c, where a, b and c are constants.

It has to be noted here in any one of the embodiments, A*B means A times B, or A multiplies B.

The preferable way is signaling of D=s(M,P)=log₂(P)−log₂(M).

Correspondingly, M meets one of the following:
M=k^{D+log}^{ₖ}^{(P)} or,
M=k^{log}^{ₖ}^{P-D}; or,
M=k^{D+log}^{ₖ}^{+C}; or,
M=k^{log}^{ₖ}^{P-D-C}; or,
M=k^{aD+b log}^{ₖ}^{(P)+c}, where a, b and c are predefined constants;
M=a1*D+b1*P+c1, where a1, b1 and c1 are constants.

In most cases, k=2.

Since only the difference between the P and M is signaled in the bitstream, additional bits spent is reduced comparing with M signaled in the bitstream. Besides, difference between the P and M can be selected based on the content or the bitrate, the flexibility of signaling the alphabet size is also increased. Thus, the above embodiment 3 combines benefits of embodiments 1 and 2: provide alphabet size selection flexibility with minimal additional bits spent to the signaling. In some rare cases when the alphabet size predicted from β works bad, encoder still can signal the difference value between M and P. It will cost a few bits, but can solve serious problems with the clipping effect.

In one embodiment, a flag can be introduced into the bitstream to indicate switching between the Embodiment 1, Embodiment 2, and Embodiment 3, in this case, two bits might be needed for this flag. In another embodiment, a flag can be used to indicate switching between the Embodiment 1 and the Embodiment 2, in this case, only one bit is needed. Such a solution provide a balance between bit saving and flexibility: for the most cases, where the derived entropy parameter is appropriate, only one bit is spent for the indication and from the other side in some specific cases there is a possibility to signal the entropy parameter explicitly.

In one embodiment, when the flag is equal to a first value specifies that the Embodiment 1 will be used, and that the entropy coding parameter or a transformation result of the entropy coding parameter is carried in the bitstream. When the flag is equal to a second value specifies that the Embodiment 2 will be used, and that the entropy coding parameter is not carried in the bitstream, but the entropy coding parameter can be derived by a decoder. When the flag is equal to a third value specifies that the Embodiment 3 will be used, and that a difference value between M and P, or a transformation result of the difference value between M and P is carried in the bitstream, where M is the size of input alphabet, and P is a predictor that can be derived by the decoder.

Besides the above embodiments, alternative signaling schemas can also be considered. And the alphabet size M can be derived by using interpolation or extrapolation process from predefined values. For example, p is signalled using one of the following codes: binary code, or unary code; or truncated unary code, or exp-Golomb code. In one possible embodiment, p is signaled using order 0 exp-Golomb code.

The above embodiments can be applied to different entropy coders, such as arithmetic coder, range coder, asymmetric numerical systems (ANS) coder and so on.

In some embodiments, more parameters of entropy coding can be selected adaptively based at least on content or bitrate. For example, parameters of entropy coding might also include: minimum symbol probability supported by the entropy coder or probability precision supported by the entropy coder, or renormalization period of the entropy coder. In some embodiments, the renormalization period can be 8 bits, 16 bits, etc. It has to be noted here that “entropy coder” can be used as a synonym of “entropy coding algorithm”, which includes both encoding and decoding algorithms. The entropy encoder is a module, which is a part of the encoder and the entropy decoder is another module, which in turn is a part of the decoder. Parameters of entropy coder and entropy decoder should be synchronized for the correct work, so, the term “parameters for entropy coder” or “entropy coding parameter” mean parameters for both entropy encoder and entropy decoder. In other words, “entropy coding parameter” can be equaled as “parameters of entropy encoder and entropy decoder”. The entropy encoder encodes symbols of the alphabet to one or more bits in a bitstream and the entropy decoder decodes one or more bits in the bitstream to the symbols of the alphabet. At entropy encoder side, the alphabet means an input alphabet, while at entropy decoder side, the alphabet means an output alphabet. A size of an input alphabet at entropy encoder side is equal to a size of an output alphabet at entropy decoder side.

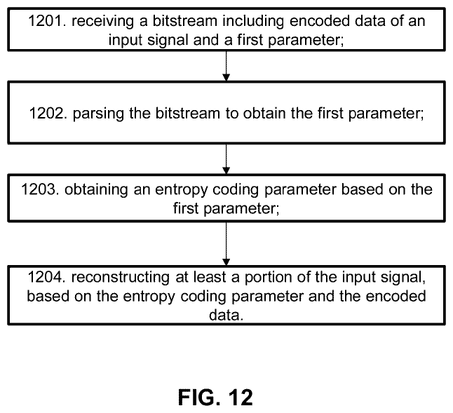

FIG. 12 is a flow diagram illustrating an exemplary decoding method implemented by a decoding apparatus, the method includes:
Operation 1201. receiving a bitstream including encoded data of an input signal and a first parameter;
Operation 1202. parsing the bitstream to obtain the first parameter;

In one possible embodiment, the input signal includes video data, image data, point claud data, motion flow, or motion vectors or any other type of media data; the encoded data means encoded result of the input signal, and the encoded data consists of a plurality of bits; the entropy coding parameter might include: a size of an alphabet of an entropy coder, where the size of the alphabet is: a size of an input alphabet of an entropy encoder, or a size of an output alphabet of an entropy decoder; or minimum symbol probability supported by the entropy coder; or renormalization period of the entropy coder. In some embodiments, the renormalization period can be 8 bits, 16 bits, etc.

Operation 1203. obtaining the entropy coding parameter based on the first parameter;

Operation 1204. reconstructing at least a portion of the input signal, based on the entropy coding parameter and the encoded data.

In the embodiments of this application, the decoder can obtain entropy coding parameter (in particular alphabet size) based on parameters carried in the bitstream, since the parameters carried in the bitstream can be changed, the encoder is able to adjust the entropy encoding parameters adaptively by changing the parameters carried in the bitstream. Thus, clipping effect can be avoided on high bitrates conditions, and the rate overhead caused by unreasonably big alphabet size for the low bitrates conditions can be avoided as well. In other words, due to adaptiveness of the entropy coding parameters, in particular the alphabet size, the optimal work of the entropy coder is possible on low bitrates (corresponding to narrow range of coded values) which results in the bitrate saving; and the absence of clipping effect is achieved on high bitrates (corresponding to wide range of coded values), which results in higher reconstruction signal quality.

In one possible embodiment, the reconstructing at least a portion of the input signal, based on the entropy coding parameter, including:
obtaining at least one probability model, where a probability model of an output symbol is used to indicate probability of each possible value of the output symbol; entropy decoding, one or more bits in the bitstream, by using the at least one probability model and the entropy coding parameter, to obtain one or more output symbols; reconstructing the at least a portion of the input signal based on the one or more output symbols.

In one possible embodiment, the method further including: updating the probability model. For example, the probability model is updated after each output symbol; so every output symbol has it's own probability distribution of the possible values. It has to be noted that probability model can also be called as probability distribution.

In one possible embodiment, the probability model is selected depends on the entropy coding parameter. For example, symbol probabilities are distributed according to the normal distribution N(μ,σ), where N(μ,σ) means Gaussian Distribution with mean value equal to μ and variance equal to σ². But the actual probability model (also means mathematical model or theoretic model), such as a quantized histogram depends on the alphabet size and probability precision within the entropy coding engine or entropy coder. The probability precision can be minimal probability supported by the entropy coding engine. That is, the entropy coding parameter might affect the histogram construction inside the entropy coder. Basically, the alphabet size is a number of possible symbol values, so if, e.g. the alphabet size is equal to 4 then bigger values, e.g. value “7” cannot be encoded/decoded.

The histogram used in the entropy coder consists of the quantized probabilities of each symbol value: e.g. alphabet is {0,1,2,3}, and corresponding probabilities are { 7/16, 7/16, 1/16, 1/16}—each probability is non-zero, sum of the probabilities is equal to 1; also each of the probabilities is more than the minimal probability supported by the entropy coding engine (probability precision) ( 1/16 in this example). If probabilities of some symbols are lower than the minimal probability supported by the entropy coding engine, the probabilities of at least some symbols need to be adjusted to insure that probabilities of each symbols are more than the minimal probability supported by the entropy coding engine. For example, the alphabet size is 8: {0, 1,2,3,4,5,6,7}, if probability of two symbol values equal to 7/16, like { 7/16, 7/16, 1/16, 1/16, 0/16, 0/16, 0/16, 0/16}, since the probabilities should be greater than or equal to 1/16. So, the probabilities of symbols “0” and “1” have to be reduced in this model from 7/16 to 5/16, e.g. and adjust probabilities of each symbols as { 5/16, 5/16, 1/16, 1/16, 1/16, 1/16, 1/16, 1/16}. Basically this is one of the explanations why the entropy coder with bigger alphabet is less efficient. If there are a lot of different possible symbol values, then each of them should have probability not less then the minimal probability supported by the entropy coder. So, even if probability of one symbol is huge, like 0.99999 . . . , in quantized histogram it will be only 1−(M−1)*pₘᵢₙ, where M is the alphabet size and pₘᵢₙ is minimal probability supported by the entropy coder. So, maximum probability in a model depends on the alphabet size and the minimal probability supported by the entropy coder: pₘₐₓ=1−(M−1)*pₘᵢₙ−pₘᵢₙ cannot be very small in practice because it's connected with the computational precision. So, if, e.g.

$${p}_{m i n} = \frac{1}{256}$$

and the alphabet size M is equal to 128, then the maximal possible probability will be equal to

$$1 - \frac{127}{256} \approx \frac{1}{2}$$

which is not so big and is not enough in some cases.

In one possible embodiment, the first parameter is the size of the alphabet; where the obtaining the entropy coding parameter based on the first parameter, including: using the first parameter as the size of the alphabet.

In another possible embodiment, the first parameter is an output p of some reversible function ƒ(M) instead of M itself, such as, the first parameter is p=f(M). In this case, the entropy coding parameter is obtained as: M=f⁻¹(p); where f⁻¹(p) is the inverse function of f(M).

In one possible embodiment, f(M) can be as follows:
f(M)=logₖ(M), where k is natural number; or,
f(M)=logₖ(M)−C, where k is natural number, C is integer number; or,
f(M)=M+R, where R is integer number; or,
f(M)=sqrt (M).

In one possible embodiment, p=f(M)=log₂(M)−9.

Correspondingly, where M meets one of the following:
M=k\hat{ }p where k is natural number; or,
M=k\hat{ }(p+C); where k is natural number, C is integer number; or,
M=k\hat{ }(a*p+b); where k is natural number, a and b are constants; or,
M=a*p+b, where a and b are constants; or,
M=p\hat{ }2.

It has to be noted that in any one of the embodiments A\hat{ }B means A^{B}.

In one possible embodiment, p=log₂(M)−9, and M=f⁻¹(p)=2\hat{ }(p+9), where f⁻¹(p) is the an inverse function of f(M), where f(M)=log₂(M)−9.

In one possible embodiment, p is signaled using one of the following codes: binary code; or unary code; or truncated unary code; or exp-Golomb code.

In one possible embodiment, p is signaled using order 0 exp-Golomb code.

In one possible embodiment, the alphabet size is signaled e.g. in a parameter set section in the bitstream, e.g. in a Picture Parameter Set section of the bitstream.

In one possible embodiment, the first parameter can be some other parameters such as rate control parameter, image resolution, video resolution, framerate, density of pixels in 3D object, some parameters of the loss function used during the training for trainable codecs, for example weighting factor for rate/distortion, or some parameters which affects gain vector g selection. The loss function might include rate and distortion components, such as Peak signal-to-noise ratio (PSNR), Multi-Scale Structural Similarity index (MS-SSIM), Video Multimethod Assessment Fusion (VMAF) or some other quality metric. For example, the loss function can be: loss=beta*distortion+bits, where the distortion is measured with PSNR or MS-SSIM or VMAF, bits is number of spent bits, and beta is a weighting parameter which controls the ratio between the bitrate and the reconstruction quality, and beta can also be called as rate control parameter. Also the first parameter could be quantization parameter, like quantization parameter (qp) in regular codecs like JPEG, HEVC, VVC. In this case, the entropy coding parameter can be derived by the decoder side based on the above other parameters.

The benefit of the above embodiment is that since quantization parameters or rate control parameters are already exist in the bitstream and are used for other procedure, such parameters can be used by the decoder side to derive the alphabet size M, there is no need for additional signaling for informaiton specifically used to indicate the alphabet size M, so bitrate can be saved.

In one possible embodiment, the obtaining the entropy coding parameter based on the first parameter, including: determining a target sub-range in which the first parameter is located; where an allowed range of values of the first parameter includes a plurality of sub-ranges, the target sub-range is one of the plurality of sub-ranges; and each of the plurality of sub-ranges includes at least one value of the first parameter, and each of the plurality of sub-ranges corresponds to one value of the entropy coding parameter; using a value of the entropy coding parameter corresponding to the target sub-range as the value of the entropy coding parameter; or, calculating the value of the entropy coding parameter based on one or more values of the entropy coding parameters corresponding to one or more sub-ranges neighboring the target sub-range.

In one possible embodiment, the first parameter is D, the entropy coding parameter includes the size of alphabet M, where M is obtained based on P and D, where P is a predictor that can be derived by a decoder.

In one possible embodiment, the first parameter can be a difference value between M and P, where M is the size of input alphabet, and P is a predictor that can be derived by a decoder by using the one of techniques described in the above Embodiment 2.

The benefit of the above embodiment is that since only the difference between the P and M is signaled in the bitstream, additional bits spent is reduced comparing with M signaled in the bitstream. Besides, difference between the P and M can be selected based on the content or the bitrate, the flexibility of signaling the alphabet size is also increased. Thus, this embodiment provides alphabet size selection flexibility with minimal additional bits spent to the signaling. In some rare cases when the alphabet size predicted from β works bad, encoder still can signal the difference value between M and P. It will cost a few bits, but can solve serious problems with the clipping effect.

In one possible embodiment, the first parameter is a value that is obtained by processing the difference value between M and P, for example, the first parameter is D=s(M,P), where s(M,P) is a reversible function; where s(M,P) can be as follows:
s(M,P)=logₖ(M)−logₖ(P), where k is natural number; or,
s(M,P)=logₖ(P)−logₖ(M), where k is natural number; or,
s(M,P)=logₖ(M)−logₖ(P)−C, where k is natural number, C is integer number; or,
s(M,P)=logₖ(P)−logₖ(M)−C, where k is natural number, C is integer number; or,
s(M,P)=a*M−b*P+c, where a, b and c are constants.

In one possible embodiment, D=s(M,P)=log₂(P)−log₂(M).

In this case, the entropy coding parameter can be obtained as: M=s⁻¹(D,P); where s⁻¹(D,P) is the inverse function of s(M,P).

It has to be noted that the reversible function D=s(M,P) can be considered as D=s_{P}(M), and M=s⁻¹(D,P) can be considered as M=s⁻¹_{P}(D), where P can be any fixed number, or in other words, P is a constant coefficient.

In one possible embodiment, D is signaled using one of the following codes: binary code; or unary code; or truncated unary code; or exp-Golomb code.

In one possible embodiment, D is signaled using order 0 exp-Golomb code.

In one possible embodiment, P can be derived based on at least one parameter other than the first parameter carried in the bitstream.

In one possible embodiment, the at least one parameters other than the first parameter includes at least one of the following: rate control parameter, quantization parameter (qp), image resolution, video resolution, framerate, density of pixels in 3D object, or rate-distortion weighting factor.

In one possible embodiment, P is derived based on the at least one parameters including: obtaining a rate control parameter beta (β) from the bitstream; determining a target sub-range in which the obtained β is located; where there is an allowed range [β_0, β_K] of the values of the rate control parameter β, and the allowed range [β_0, β_K] is split to a plurality of sub-ranges, the target sub-range is one of the plurality of sub-ranges; each of the plurality of sub-ranges includes at least one value of B, and each of the plurality of sub-ranges corresponds to one value of P; choosing a value corresponding to the target sub-range as the value of P; or, calculating the value of P based on one or more values corresponding to one or more sub-ranges neighboring the target sub-range.

In one possible embodiment, the entropy coder is an arithmetic coder, or a range coder, or an asymmetric numerical systems (ANS) coder.

In an embodiment, the method further including:

Operation 1205. parsing the bitstream to obtain a flag, where the flag is used to indicate whether the entropy coding parameter is carried in the bitstream directly.

In the above embodiment, a flag can be introduced into the bitstream to indicate switching between three embodiments, in this case, two bits might be needed for this flag. In another possible embodiment, a flag can be used to indicate switching between two embodiments, in this case, only one bit is needed.

In one possible embodiment, when the flag is equal to a first value specifies that the entropy coding parameter is carried in the bitstream, and in this case, the first parameter is the entropy coding parameter or the first parameter is a transformation result of the entropy coding parameter; or where when the flag is equal to a second value specifies that the entropy coding parameter is not carried in the bitstream, and the entropy coding parameter can be derived by a decoder.

Such a solution provide a balance between bit saving and flexibility: for the most cases, where the derived entropy parameter is appropriate, only one bit is spent for the indication and from the other side in some specific cases there is a possibility to signal the entropy parameter explicitly.

In one possible embodiment, when the flag is equal to a third value specifies that a difference value between M and P, or a transformation result of the difference value between M and P is carried in the bitstream, in this case, the first parameter is the difference value between M and P, or a transformation result of the difference value between M and P, where M is the size of input alphabet, and P is a predictor that can be derived by the decoder.

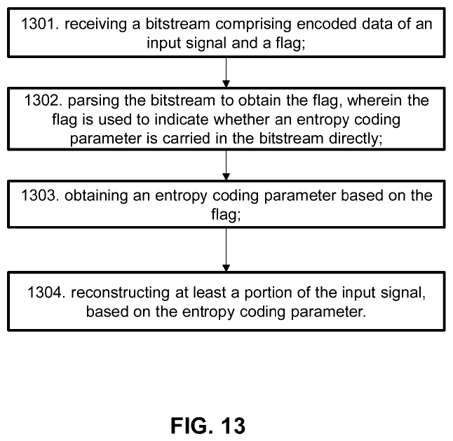

FIG. 13 is a flow diagram illustrating an exemplary decoding method implemented by a decoding apparatus, the method includes:
1301. receiving a bitstream including decoded data of an input signal and a flag;
1302. parsing the bitstream to obtain the flag, where the flag is used to indicate whether an entropy coding parameter is carried in the bitstream directly;
1303. obtaining an entropy coding parameter based on the flag;
1304. reconstructing at least a portion of the input signal, based on the entropy coding parameter and the encoded data.

In the above embodiment, a flag can be introduced into the bitstream to indicate switching between three embodiments, in this case, two bits might be needed for this flag. In another possible embodiment, a flag can be used to indicate switching between two embodiments, in this case, only one bit is needed. Such a solution provide a balance between bit saving and flexibility: for the most cases, where the derived entropy parameter is appropriate, only one bit is spent for the indication and from the other side in some specific cases there is a possibility to signal the entropy parameter explicitly.

In one possible embodiment, the entropy coding parameter includes at least one of the following: a size of an alphabet of an entropy coder, where the size of the alphabet is: a size of an input alphabet of an entropy encoder, or a size of an output alphabet of an entropy decoder; or minimum symbol probability supported by the entropy coder; or renormalization period of the entropy coder. In some embodiments, the renormalization period can be 8 bits, 16 bits, etc.

In one possible embodiment, the input signal includes video data, image data, point claud data, motion flow, or motion vectors or any other type of media data.

In one possible embodiment, when the flag is equal to a first value specifies that the entropy coding parameter is carried in the bitstream, or transformation result of the entropy coding parameter in the bitstream. It has to be noted that the transformation result of the entropy coding parameter means a result, such as a value, obtained by processing the entropy coding parameter. When the flag is equal to a second value specifies that the entropy coding parameter is not carried in the bitstream, but the entropy coding parameter can be derived by a decoder. In this case, the flag is used to indicate switching between the above Embodiment 1 and the Embodiment 2, only one bit is needed.

Such a solution provide a balance between bit saving and flexibility: for the most cases, where the derived entropy parameter is appropriate, only one bit is spent for the indication and from the other side in some specific cases there is a possibility to signal the entropy parameter explicitly.

In an embodiment, the flag can be used to indicate switching between the above Embodiment 1, the Embodiment 2, and the Embodiment 3, in this case, the flag has three possible values, and two bits are needed, and when the flag is equal to a third value specifies that a difference value between M and P is carried in the bitstream, or a transformation result of the difference value between M and P is carried in the bitstream, where M is the entropy coding parameter, and P is a predictor that can be derived by the decoder. It has to be noted that the transformation result of the difference value between M and P means a result of processing the difference value between M and P.

In one possible embodiment, the obtaining the entropy coding parameter based on the flag, including: when the flag is equal to the first value, parsing the bitstream to obtain a first parameter; where the first parameter is the entropy coding parameter; using the first parameter as the entropy coding parameter; or, where the first parameter is the transformation result of the entropy coding parameter; obtaining entropy coding parameter based on the first parameter.

In one possible embodiment, the transformation result of the entropy coding parameter is p=f(M), where M is the entropy coding parameter, where f(M) includes as follows: f(M)=logₖ(M), where k is natural number; or, f(M)=logₖ(M)−C, where k is natural number, C is integer number; or, f(M)=M+R, where R is integer number; or, f(M)=sqrt (M); where the obtaining entropy coding parameter based on the first parameter, includes: M=f⁻¹(p); where f⁻¹(p) is the inverse function of f(M).

Correspondingly, M meets one of the following:
M=k^{p} where k is natural number; or,
M=k^{p+C}, where k is natural number, C is integer number; or,
M=ap+b, where a and b are constants; or,
M=p².

In one possible embodiment, k=2.

In one possible embodiment, the first parameter is p=log₂(M)−9.

In one possible embodiment, the obtaining the entropy coding parameter based on the flag, including: when the flag is equal to the second value, parsing the bitstream to obtain a second parameter, where the second parameter includes at least one of: a rate control parameter, a quantization parameter (qp), image resolution, video resolution, framerate, density of pixels in 3D object, or rate-distortion weighting factor; deriving the entropy coding parameter based on the second parameter.

In one possible embodiment, the deriving the entropy coding parameter based on the second parameter including: determining a target sub-range in which the second parameter is located; where an allowed range of values of the second parameter includes a plurality of sub-ranges, the target sub-range is one of the plurality of sub-ranges; and each of the plurality of sub-ranges includes at least one value of the second parameter, and each of the plurality of sub-ranges corresponds to one value of the entropy coding parameter; using a value of the entropy coding parameter corresponding to the target sub-range as the value of the entropy coding parameter; or, calculating the value of the entropy coding parameter based on one or more values of the entropy coding parameters corresponding to one or more sub-ranges neighboring the target sub-range.

In one possible embodiment, the obtaining the entropy coding parameter based on the flag, including: when the flag is equal to the third value, parsing the bitstream to obtain a third parameter, where the third parameter is the difference value between M and P, or the third parameter is a transformation result of the difference value between M and P; where M is the entropy coding parameter, and P is a predictor that can be derived by the decoder; deriving P based on at least one of: a rate control parameter, a quantization parameter (qp), image resolution, video resolution, framerate, density of pixels in 3D object, or rate-distortion weighting factor; obtaining entropy coding parameter based on the third parameter and P.

In one possible embodiment, the transformation result of the difference value between M and P is D=s(M,P), where s(M,P) is a reversible function; where s(M,P) includes as follows:
s(M,P)=logₖ(M)−logₖ(P), where k is natural number; or,
s(M,P)=logₖ(P)−logₖ(M), where k is natural number; or, s(M,P)=logₖ(M)−logₖ(P)−C, where k is natural number, C is integer number; or,
s(M,P)=logₖ(P)−logₖ(M)−C, where k is natural number, C is integer number; or,
s(M,P)=a*logₖ(P)+b*logₖ(M)−c, where a, b and c are constants;
s(M,P)=a*M−b*P+c, where a, b and c are constants;
   where the obtaining entropy coding parameter based on the third parameter, including: M=s⁻¹(D,P); where s⁻¹(D,P) is the inverse function of s(M,P). It has to be noted here, A*B means A times B, or A multiplies B.

In one possible embodiment, M meets one of the following:
M=k^{D+log}^{ₖ}^{(P)} or,
M=k^{log}^{ₖ}^{P-D}; or,
M=k^{D+log}^{ₖ}^{P+C}; or,
M=k^{log}^{ₖ}^{P-D-C}; or,
M=k^{aD+b log}^{ₖ}^{(P)+c}
M=a1*D+b1*P+c1, where a1, b1 and c1 are constants.

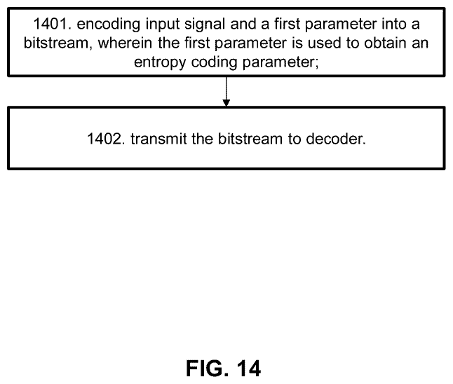

FIG. 14 is a flow diagram illustrating an exemplary encoding method implemented by an encoding apparatus, the method includes:

Operation 1401. encoding input signal and a first parameter into a bitstream, where the first parameter is used to obtain an entropy coding parameter;

In one possible embodiment, the input signal includes video data, image data, point claud data, motion flow, or motion vectors or any other type of media data; the entropy coding parameter includes at least one of the following: a size of an alphabet of an entropy coder, where the size of the alphabet is: a size of an input alphabet of an entropy encoder, or a size of an output alphabet of an entropy decoder; or minimum symbol probability supported by the entropy coder; or renormalization period of the entropy coder. In some embodiments, the renormalization period can be 8 bits, 16 bits, etc.

Operation 1402. transmit the bitstream to a decoder.

In one possible embodiment, the first parameter is the size of alphabet.

In one possible embodiment, the first parameter is p, where p is a transformation result of M, and M is the entropy coding parameter.

In one possible embodiment, p=f(M), where f(M) is a reversible function.

In one possible embodiment, f(M) includes as follows:
f(M)=logₖ(M), where k is natural number; or,
f(M)=logₖ(M)−C, where k is natural number, C is integer number; or,
f(M)=a*M+b, where a and b are constants; or,
f(M)=sqrt(M).

In one possible embodiment, p=log₂(M)−9.

In one possible embodiment, p is signaled using one of the following codes: binary code; or unary code; or truncated unary code; or exp-Golomb code.

In one possible embodiment, the first parameter includes at least one of the following: a rate control parameter, a quantization parameter (qp), image resolution, video resolution, framerate, density of pixels in 3D object, or rate-distortion weighting factor; where the first parameter is used by the entropy decoder to derive the entropy coding parameter.

In one possible embodiment, the first parameter is D that is obtained based on P and M, where M is the entropy coding parameter, and P is a predictor that can be derived by a decoder.

In one possible embodiment, D=s(M,P), where s(M,P) is a reversible function.

In one possible embodiment, s(M,P) includes as follows:
s(M,P)=logₖ(M)−logₖ(P), where k is natural number; or,
s(M,P)=logₖ(P)−logₖ(M), where k is natural number; or,
s(M,P)=logₖ(M)−logₖ(P)−C, where k is natural number, C is integer number; or,
s(M,P)=logₖ(P)−logₖ(M)−C, where k is natural number, C is integer number;
or,
s(M,P)=a*M−b*P+c, where a, b and c are constants.

In one possible embodiment, D=s(M,P)=log₂(P)−log₂(M).

In one possible embodiment, D is signaled using one of the following codes: binary code; or unary code; or truncated unary code; or exp-Golomb code.

In one possible embodiment, the encoding method further including:

encoding a flag into the bitstream, where the flag is used to indicate whether the entropy coding parameter is carried in the bitstream directly.

In one possible embodiment, when the flag is equal to a first value specifies that the entropy coding parameter is carried in the bitstream, and the first parameter is the entropy coding parameter or the first parameter is a transformation result of the entropy coding parameter; or where when the flag is equal to a second value specifies that the entropy coding parameter is not carried in the bitstream, but the entropy coding parameter can be derived by a decoder.

In one possible embodiment, when the flag is equal to a third value specifies that a difference value between M and P is carried in the bitstream, or a transformation result of the difference value between M and P is carried in the bitstream, where M is the entropy coding parameter, and P is a predictor that can be derived by the decoder.

In one possible embodiment, several possible solutions are proposed for alphabet selection on encoder-side.

In one possible embodiment, before encoding the first parameter into the bitstream, the encoding method further including:
determining the size of the alphabet of the entropy encoder based on at least one of bitrate or coded values of the image data.

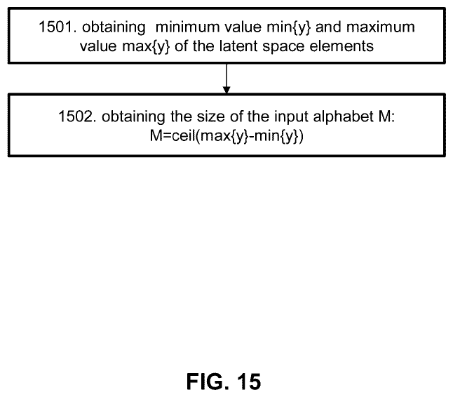

FIG. 15 is a flow diagram illustrating an exemplary method for determining the size of the alphabet of the entropy encoder, the method includes:

Operation 1501. obtaining minimum value and maximum value of the latent space elements; Operation 1502. obtaining the size of the input alphabet as follows:

M=ceil(max{y}−min{y})

where, ceil(x) is the smallest integer number higher than x, max{y} indicates the maximum value of the latent space elements, min{y} indicates the minimum value of the latent space elements, and M indicates the size of the alphabet.

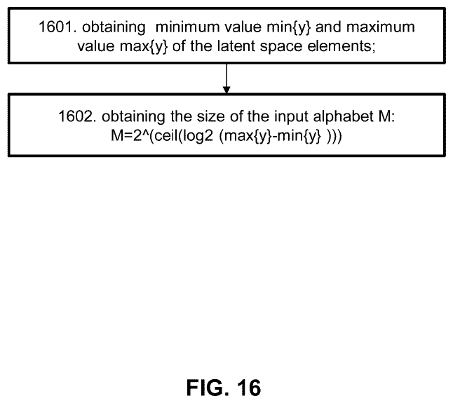

FIG. 16 is a flow diagram illustrating an exemplary method for determining the size of the alphabet of the entropy encoder, the method includes:

Operation 1601. obtaining minimum value and maximum value of the latent space elements;

Operation 1602. obtaining the size of the input alphabet as follows:

M=2\hat{ }(ceil(log₂(max{y}−min{y}))),

where, ceil(x) is the smallest integer number higher than x, max{y} indicates the maximum value of the latent space elements, min{y} indicates the minimum value of the latent space elements, and M indicates the size of the alphabet. For most of the entropy coders the alphabet size should be the power of 2, the alphabet size in this case can be selected as M=2\hat{ }(ceil(log₂(max{y}−min{y}))). It should be noticed that there are some cases, e.g. when module of all y values is smaller than 1, the additional scaling operation can be performed before the entropy coding.

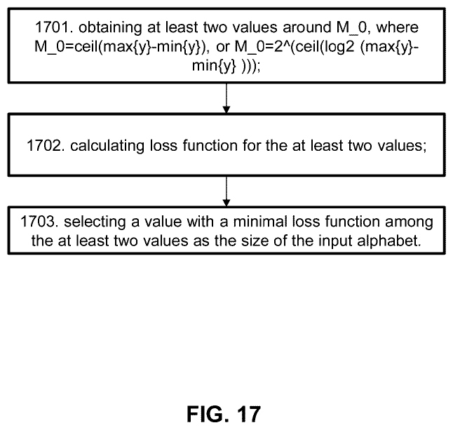

FIG. 17 is a flow diagram illustrating an exemplary method for determining the size of the alphabet of the entropy encoder, the method includes:
Operation 1701. obtaining at least two values around M_0, where M_0=ceil(max{y}−min{y}), or M_0=2\hat{ }(ceil(log₂(max{y}−min{y})));
Operation 1702. calculating loss function for the at least two values;
Operation 1703. selecting a value with a minimal loss function among the at least two values as the size of the input alphabet.

Where, ceil(x) is the smallest integer number higher than x, max{y} indicates the maximum value of the latent space elements, min{y} indicates the minimum value of the latent space elements.

For example, the loss function can be: loss=beta distortion+bits, where the distortion is measured with PSNR or MS-SSIM or VMAF, bits is number of spent bits, and beta is a weighting parameter which controls the ratio between the bitrate and the reconstruction quality, and beta can also be called as rate control parameter. Within this approach clipping can occurs sometimes, but the bitrate saving due to usage of smaller alphabet compensate minor distortion increase.

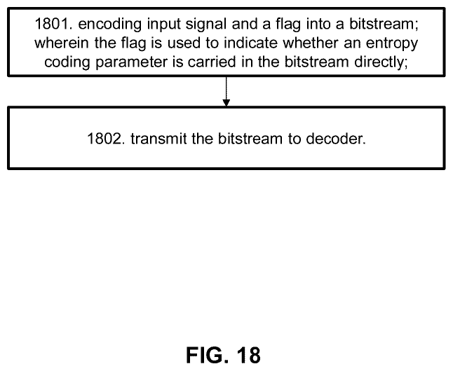

FIG. 18 is a flow diagram illustrating an exemplary encoding method implemented by a encoding apparatus, the method includes:

Operation 1801. encoding input signal and a flag into a bitstream; where the flag is used to indicate whether an entropy coding parameter is carried in the bitstream directly;

Operation 1802. transmit the bitstream to a decoder.

In one possible embodiment, the input signal includes video data, image data, point claud data, motion flow, or motion vectors or any other type of media data; the entropy coding parameter includes at least one of the following: a size of an alphabet of an entropy coder, where the size of the alphabet is: a size of an input alphabet of an entropy encoder, or a size of an output alphabet of an entropy decoder; or minimum symbol probability supported by the entropy coder; or renormalization period of the entropy coder.

In one possible embodiment, the flag is used to indicate switching between the above Embodiment 1 and the Embodiment 2, in this case, only one bit is needed. When the flag is equal to a first value specifies that the entropy coding parameter is carried in the bitstream, or transformation result of the entropy coding parameter in the bitstream; or when the flag is equal to a second value specifies that the entropy coding parameter is not carried in the bitstream, but the entropy coding parameter can be derived by a decoder.

Such a solution provide a balance between bit saving and flexibility: for the most cases, where the derived entropy parameter is appropriate, only one bit is spent for the indication and from the other side in some specific cases there is a possibility to signal the entropy parameter explicitly.

In an embodiment, the flag can be used to indicate switching between the above Embodiment 1, the Embodiment 2, and the Embodiment 3, in this case, the flag has three possible values, and two bits are needed. When the flag is equal to a third value specifies that a difference value between M and P is carried in the bitstream, or a transformation result of the difference value between M and P is carried in the bitstream, where M is the entropy coding parameter, and P is a predictor that can be derived by the decoder.

In one possible embodiment, when the flag is equal to the first value, encoding a first parameter into the bitstream; where the first parameter is the entropy coding parameter or the first parameter is transformation result of the entropy coding parameter.

In one possible embodiment, the transformation result of the entropy coding parameter is p=f(M), where M is the entropy coding parameter, where f(M) can be as follows:
f(M)=logₖ(M), where k is natural number; or,
f(M)=logₖ(M)−C, where k is natural number, C is integer number; or,
f(M)=aM+b, where a and b are constants; or,
f(M)=sqrt (M).

In one possible embodiment, the first parameter is p=log₂(M)−9.

In one possible embodiment, p is signaled using one of the following codes: binary code; or unary code; or truncated unary code; or exp-Golomb code.

In one possible embodiment, p is signaled using order 0 exp-Golomb code.

In one possible embodiment, the method further including: when the flag is equal to the third value, encoding a third parameter into the bitstream, where the third parameter is the difference value between M and P, or the third parameter is transformation result of the difference value between M and P.

In one possible embodiment, the transformation result of the difference value between M and P is D=s(M,P), where s(M,P) is a reversible function; where s(M,P) includes as follows:
s(M,P)=logₖ(M)−logₖ(P), where k is natural number; or,
s(M,P)=logₖ(P)−logₖ(M), where k is natural number; or,
s(M,P)=logₖ(M)−logₖ(P)−C, where k is natural number, C is integer number; or,
s(M,P)=logₖ(P)−logₖ(M)−C, where k is natural number, C is integer number; or,
s(M,P)=a*logₖ(P)−b*logₖ(M)−c, where a, b and c are constants;
s(M,P)=a*M−b*P+c, where a, b and c are constants;
   where the obtaining entropy coding parameter based on the third parameter, including: M=s⁻¹(D,P); where s⁻¹(D,P) is the inverse function of s(M,P).

In one possible embodiment, D is signaled using one of the following codes: binary code; or unary code; or truncated unary code; or exp-Golomb code.

In one possible embodiment, D is signaled using order 0 exp-Golomb code.

An embodiment of this application provides a decoding apparatus, including: a receive unit, configured to: receive a bitstream including encoded data of an input signal; a parse unit, configured to: parse the bitstream to obtain a first parameter; an obtain unit, configured to: obtain an entropy coding parameter based on the first parameter; a reconstruction unit, configured to: reconstruct at least a portion of the input signal, based on the entropy coding parameter.

The apparatuses provide the advantages of the methods described above.

In one possible embodiment, the input signal includes video data, image data, point claud data, motion flow, or motion vectors or any other type of media data.

In one possible embodiment, the entropy coding parameter includes at least one of the following: a size of an alphabet of an entropy coder, where the size of the alphabet is: a size of an input alphabet of an entropy encoder, or a size of an output alphabet of an entropy decoder; or minimum symbol probability supported by the entropy coder; or renormalization period of the entropy coder. In some embodiments, the renormalization period can be 8 bits, 16 bits, etc.

In one possible embodiment, the first parameter is the size of the alphabet; where the obtain unit, is further configured to: use the first parameter as the size of the alphabet.

In one possible embodiment, the first parameter is p, the entropy coding parameter includes the size of the alphabet M, and M is a function of p.

In one possible embodiment, the obtain unit, is further configured to: obtain M as M=f⁻¹(p); where f⁻¹(p) is an inverse function of f(M), where f(M)=p.

In one possible embodiment, the obtain unit, is further configured to: determine a target sub-range in which the first parameter is located; where an allowed range of values of the first parameter includes a plurality of sub-ranges, the target sub-range is one of the plurality of sub-ranges; and each of the plurality of sub-ranges includes at least one value of the first parameter, and each of the plurality of sub-ranges corresponds to one value of the entropy coding parameter; use a value of the entropy coding parameter corresponding to the target sub-range as the value of the entropy coding parameter; or, calculate the value of the entropy coding parameter based on one or more values of the entropy coding parameters corresponding to one or more sub-ranges neighboring the target sub-range.

An embodiment of this application provides a decoding apparatus, including: functional units to implement any one of the above encoding methods.

An embodiment of this application provides an encoding apparatus, including: an encoding unit, configured to: encode input signal and a first parameter into a bitstream; where the first parameter is used to obtain an entropy coding parameter; a transmit unit, configured to transmit the bitstream to a decoder. The encoding apparatus further including other functional units to implement any one of the foregoing encoding methods.

An embodiment of this application provides a decoding apparatus, including: processing circuitry configured to: perform any one of the foregoing decoding methods.

An embodiment of this application provides an encoding apparatus, including: processing circuitry configured to: perform any one of the foregoing encoding methods.

An embodiment of this application provides a decoder including: one or more processors; and a non-transitory computer-readable storage medium coupled to the one or more processors, where the storage medium stores programming for execution by the one or more processors, where the programming, when executed by the one or more processors, configures the decoder to carry out any one of the foregoing decoding methods.

An embodiment of this application provides an encoder including: one or more processors; and a non-transitory computer-readable storage medium coupled to the one or more processors, where the storage medium stores programming for execution by the one or more processors, where the programming, when executed by the one or more processors, configures the decoder to carry out any one of the foregoing encoding methods.

An embodiment of this application provides a non-transitory computer-readable medium carrying computer instructions which, when executed by a computer device or one or more processors, cause the computer device or the one or more processors to perform any one of the foregoing encoding methods.

An embodiment of this application provides a non-transitory computer-readable medium carrying computer instructions which, when executed by a computer device or one or more processors, cause the computer device or the one or more processors to perform any one of the foregoing decoding methods.

An embodiment of this application provides a non-transitory storage medium including a bitstream encoded by any one of the foregoing encoding methods.

An embodiment of this application provides a computer program stored on a non-transitory medium and including code instructions, which, when executed on one or more processors, cause the one or more processor to execute steps of any one of the foregoing encoding methods.

An embodiment of this application provides a computer program stored on a non-transitory medium and including code instructions, which, when executed on one or more processors, cause the one or more processor to execute steps of any one of the foregoing decoding methods.

An embodiment of this application provides a system for delivering a bitstream, including: at least one storage medium, configured to store at least one bitstream generated by the encoding method described in the third aspect or any one of the possible embodiments of the third aspect, the fourth aspect or any one of the possible embodiments of the fourth aspect; a video streaming device, configured to obtain a bitstream from one of the at least one storage medium, and send the bitstream to a terminal device; where the video streaming device includes a content server or a content delivery server.

In one possible embodiment, further including: one or more processor, configured to perform encryption processing on at least one bitstream to obtain at least one encrypted bitstream; the at least one storage medium, configured to store the encrypted bitstream; or, the one or more processor, configured to converting a bitstream in a first format into a bitstream in a second format; the at least one storage medium, configured to store the bitstream in the second format.

In one possible embodiment, further including: a receiver, configured to receive a first operation request; and; the one or more processor, configured to determine a target bitstream in the at least one storage medium in response to the first operation request; a transmitter, configured to send the target bitstream to a terminal-side apparatus.

In one possible embodiment, the one or more processor is further configured to: encapsulate a bitstream to obtain a transport stream in a first format; and the transmitter, is further configured to: send the transport stream in the first format to a terminal-side apparatus for display; or, send the transport stream in the first format to storage space for storage.

In one possible embodiment, an exemplary method for storing a bitsteam is provided, the method includes:
obtaining a bitstream according to any one of the encoding methods illustrated before;
storing the bitstream in a storage medium.

In an embodiment, the method further includes:
performing encryption processing on the bitstream to obtain an encrypted bitstream; and;
storing the encrypted bitstream in the storage medium.

It should be understood that any of the known encryption methods may be employed.

In an embodiment, the method further includes:
performing segmentation processing on the bitstream to obtain multiple bitstream segments; storing the plurality of bitstream segments into a storage medium.

In an embodiment, the method further includes:
obtaining at least one backup of the bitstream, and storing the at least one backup in a storage medium. It should be understood that the at least one backup of the bitstream can be stored in a different storage medium than the storage medium that store the original bitstream.

In an embodiment, the method further includes:
receiving a plurality of bitstreams generated according to any one of the encoding methods illustrated before;
separately allocating address information or identification information to the plurality of bitstreams; and;
storing the bitstreams in a corresponding location according to the address information or identification information corresponding to the multiple bitstreams.

In an embodiment, the method further includes:
classifying the bitstreams to obtain at least two bitstreams, where the at least two bitstreams comprise a first bitstream and a second bitstream; and;
storing the first bitstream in a first storage space, and storing the second bitstream in a second storage space.

In an embodiment, the method further includes:
sending, by a video streaming device, the bitstream to a terminal device, where the video streaming device can be a content server or a content delivery server.

In one possible embodiment, an exemplary system for storing a bitstream is provided, the system, including:
a receiver, configured to receive a bitstream generated by any one of the before encoding methods; and;
a processor, configured to perform encryption processing on the bitstream to obtain an encrypted bitstream; and;
a computer readable storage medium, configured to store the encrypted bitstream.

In an embodiment, the system includes several storage mediums, and the several storage mediums can be deployed in different locations. And a plurality of bitstreams may be stored in different storage media in a distributed manner. For example, the several storage mediums include: a first storage medium, configured to store a first bit stream; a second storage medium, configured to store a second bit stream.

In an embodiment, the system includes a video streaming device, where the video streaming device can be a content server or a content delivery server, where the video streaming device is configured to obtain a bitstream from one of the storage mediums, and send the bitstream to a terminal device.

In one possible embodiment, an exemplary method for converting format of a bitsteam is provided, the method includes:
receiving a bitstream in a first format generated by any one of the encoding methods illustrated before;
converting the bitstream in the first format into a bitstream in a second format;
storing the bitstream in the second format in a storage medium.

In an embodiment, the method further includes:
sending the stored bitstream in the second format to a terminal-side apparatus in response to an access request of the terminal-side apparatus.

In one possible embodiment, an exemplary system for converting a bitstream format is provided, the system including:
a receiver, configured to receive a bitstream in a first format generated by any one of the encoding methods illustrated before; and;
a processor, configured to convert the bitstream in the first format into a bitstream in a second format; and;
the processor is further configured to store the bitstream in the second format into a storage medium; and;
the storage medium is configured to store the bitstream in the second format; and;
a transmitter, configured to send the stored bitstream in the second format to a terminal-side apparatus in response to an access request of the terminal-side apparatus.

In one possible embodiment, an exemplary method for processing a bitsteam is provided, the method includes:
receiving a transport stream including a video stream and an audio stream, where the video stream is generated by any one of the encoding methods illustrated before;
demultiplexing the transport stream to separate the video stream and the audio stream; and;
decoding the video stream by using a video decoder to obtain video data; and;
decoding the audio stream by using an audio decoder to obtain audio data.

In an embodiment, the method further includes:
synchronizing the audio data and the video data;
outputting the synchronization result to the player for playback.

In an embodiment, the method further includes:
decoding the bitstream to obtain video data or image data; and;
performing at least one of luminance mapping, chroma mapping, resolution adjustment, or format conversion on the video data or image data, and sending the video data or image data to a display.

In one possible embodiment, an exemplary method for transmitting a bitsteam based on an user operation request is provided, the method including:
receiving a first operation request from an end-side apparatus, where the first operation request is used to request to play a target video;
determining, in a storage medium in response to the first operation request, a bitstream corresponding to the target video, where the bitstream corresponding to the target video is a bitstream generated according to any one of the encoding methods illustrated before; and;
sending the target bitstream to the end-side apparatus.

In an embodiment, the method further includes:
encapsulating the bitstream to obtain a transport stream in a first format; and;
sending the transport stream in the first format to a terminal-side apparatus for display; or,
sending the transport stream in the first format to storage space for storage.

In one possible embodiment, an exemplary system for transmitting a bitsteam based on an user operation request is provided, the system including:
a storage medium configured to store a bitstream, where the bitstream is a bitstream generated according to any one of the encoding methods illustrated before;
a receiver, configured to receive a first operation request; and;
a processor, configured to determine a target bitstream in the storage medium in response to the first operation request,
a transmitter, configured to send the target bitstream to a terminal-side apparatus.

In an embodiment, the processor is further configured to:
encapsulate the bitstream to obtain a transport stream in a first format; and the system further includes a transmitter, configured to:
send the transport stream in the first format to a terminal-side apparatus for display; or,
send the transport stream in the first format to storage space for storage.

In one possible embodiment, an exemplary method for downloading a bitsteam is provided, the method includes:
obtaining a bitstream from a storage medium, where the bitstream is generated according to any one of the encoding methods illustrated before; and;
decoding the bitstream to obtain a streaming media file;
dividing the streaming media file into multiple streaming media segments;
downloading the multiple streaming media segments separately.

In one possible embodiment, an exemplary system for downloading a bitsteam is provided, the system includes:
an obtaining unit, configured to obtain a bitstream from a storage medium, where the bitstream is generated according to any one of the encoding methods illustrated before; and;
a decoder, configured to decode the bitstream to obtain a streaming media file;
a processor, configured to divide the streaming media file into multiple streaming media segments;
the processor, configured to download the multiple streaming media segments separately. However, the present invention is not limited to any of these exemplary implementations.

The arithmetic decoding may be performed in parallel, for example by a multi-core decoder. In addition, only parts of the arithmetic decoding may be performed in parallel. The method of arithmetic decoding may be realized as a range coding.

The arithmetic coding of the present disclosure may be readily applied to encoding of feature maps of a neural network or in classic picture (still or video) encoding and decoding. The neural networks may be used for any purpose, in particular for encoding and decoding or pictures (still or moving), or encoding and decoding of picture-related data such as motion flow or motion vectors or other parameters. The neural network may also be used for computer vision applications such as classification of images, depth detection, segmentation map determination, object recognition of identification or the like.

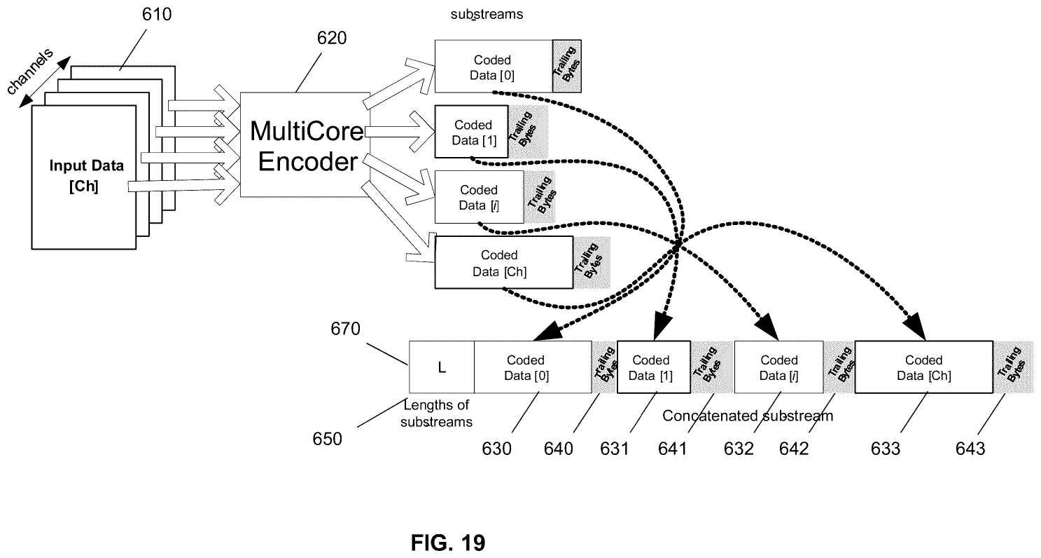

The entropy decoding may be performed in parallel, for example by a multi-core decoder. In addition, only parts of the entropy decoding may be performed in parallel. FIG. 19 shows an exemplary scheme of a parallel (e.g. a multi-core) encoder 620. Each of the input data channels 610 may be encoded into an individual substream including coded bits 630-633 and trailing bits 640-643. The lengths of the substreams 650 are signaled. In parallel processing implementations, the bitstream consists of several substreams, which are concatenated in a final step. Each of the substreams needs to be finalized. This because the substreams are encoded independently of each other, so that the encoding (and thus also decoding) of one substream does not require previous encoding (or decoding) of another one or more substreams.

The input data channels may refer to channels obtained by processing some data by a neural network. For example, the input data may be feature channels such as output channels or latent representation channels of a neural network. In an exemplary implementation, the neural network is a deep neural network and/or a convolutional neural network or the like. The neural network may be trained to process pictures (still or moving). The processing may be for picture encoding and reconstruction or for computer vision such as object recognition, classification, segmentation, or the like. In general, the present disclosure is not limited to any particular kind of tasks or neural networks. Rather, the present disclosure is applicable for encoding any kind of data coming from a plurality of channels, which are to be generally understood as any sources of data. Moreover, the channels may be provided by a pre-processing of source data.

Implementation within Picture Coding

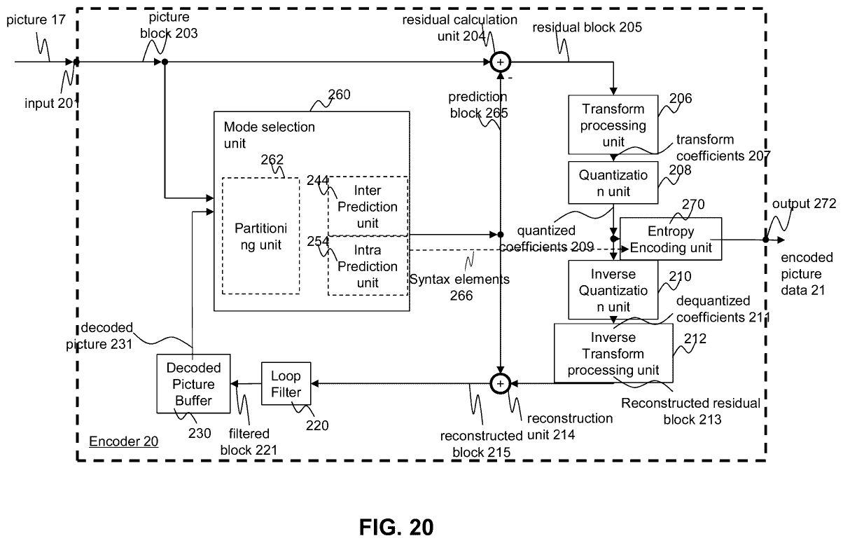

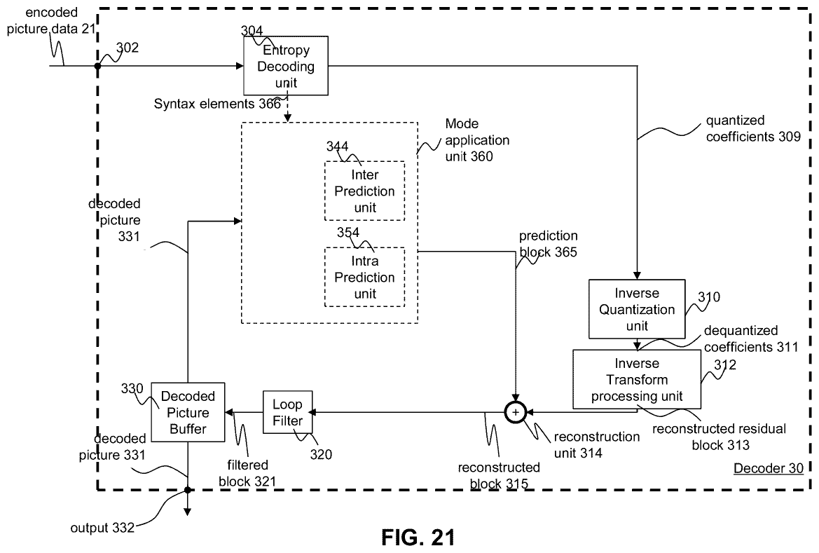

One possible deployment can be seen in FIGS. 20 and 21.

FIG. 20 shows a schematic block diagram of an example encoder 20 that is configured to implement the techniques of the present application. In the example of FIG. 20, the encoder 20 includes an input 201 (or input interface 201), a residual calculation unit 204, a transform processing unit 206, a quantization unit 208, an inverse quantization unit 210, and inverse transform processing unit 212, a reconstruction unit 214, a loop filter unit 220, a decoded picture buffer (DPB) 230, a mode selection unit 260, an entropy encoding unit 270 and an output 272 (or output interface 272). The entropy coding 270 may implement the arithmetic coding methods or apparatuses as described above.

The mode selection unit 260 may include an inter prediction unit 244, an intra prediction unit 254 and a partitioning unit 262. Inter prediction unit 244 may include a motion estimation unit and a motion compensation unit (not shown). An encoder 20 as shown in FIG. 20 may also be referred to as hybrid encoder or an encoder according to a hybrid video/image codec.

The encoder 20 may be configured to receive, e.g. via input 201, a picture 17 (or picture data 17 or point claud data, motion flow or other type of media data), e.g. picture of a sequence of pictures forming a video or video sequence. The received picture or picture data may also be a pre-processed picture 19 (or pre-processed picture data 19). For sake of simplicity the following description refers to the picture 17. The picture 17 may also be referred to as current picture or picture to be coded (in particular in video coding to distinguish the current picture from other pictures, e.g. previously encoded and/or decoded pictures of the same video sequence, i.e. the video sequence which also includes the current picture).

A (digital) picture is or can be regarded as a two-dimensional array or matrix of samples with intensity values. A sample in the array may also be referred to as pixel (short form of picture element) or a pel. The number of samples in horizontal and vertical direction (or axis) of the array or picture define the size and/or resolution of the picture. For representation of color, typically three color components are employed, i.e. the picture may be represented or include three sample arrays. In RGB format or color space a picture includes a corresponding red, green and blue sample array. However, in video coding each pixel is typically represented in a luminance and chrominance format or color space, e.g. YCbCr, which includes a luminance component indicated by Y (sometimes also L is used instead) and two chrominance components indicated by Cb and Cr. The luminance (or short luma) component Y represents the brightness or grey level intensity (e.g. like in a grey-scale picture), while the two chrominance (or short chroma) components Cb and Cr represent the chromaticity or color information components. Accordingly, a picture in YcbCr format includes a luminance sample array of luminance sample values (Y), and two chrominance sample arrays of chrominance values (Cb and Cr). Pictures in RGB format may be converted or transformed into YcbCr format and vice versa, the process is also known as color transformation or conversion. If a picture is monochrome, the picture may comprise only a luminance sample array. Accordingly, a picture may be, for example, an array of luma samples in monochrome format or an array of luma samples and two corresponding arrays of chroma samples in 4:2:0, 4:2:2, and 4:4:4 color format.

Embodiments of the encoder 20 may comprise a picture partitioning unit (not depicted in FIG. 20) configured to partition the picture 17 into a plurality of (typically non-overlapping) picture blocks 203. These blocks may also be referred to as root blocks, macro blocks (H.264/AVC) or coding tree blocks (CTB) or coding tree units (CTU) (H.265/HEVC and VVC). The picture partitioning unit may be configured to use the same block size for all pictures of a video sequence and the corresponding grid defining the block size, or to change the block size between pictures or subsets or groups of pictures, and partition each picture into the corresponding blocks. The abbreviation AVC stands for Advanced Video Coding.

In further embodiments, the encoder 20 may be configured to receive directly a block 203 of the picture 17, e.g. one, several or all blocks forming the picture 17. The picture block 203 may also be referred to as current picture block or picture block to be coded.

Like the picture 17, the picture block 203 again is or can be regarded as a two-dimensional array or matrix of samples with intensity values (sample values), although of smaller dimension than the picture 17. In other words, the block 203 may comprise, e.g., one sample array (e.g. a luma array in case of a monochrome picture 17, or a luma or chroma array in case of a color picture) or three sample arrays (e.g. a luma and two chroma arrays in case of a color picture 17) or any other number and/or kind of arrays depending on the color format applied. The number of samples in horizontal and vertical direction (or axis) of the block 203 define the size of block 203. Accordingly, a block may, for example, an M×N (M-column by N-row) array of samples, or an M×N array of transform coefficients.

Embodiments of the encoder 20 as shown in FIG. 20 may be configured to encode the picture 17 block by block, e.g. the encoding and prediction is performed per block 203.

Embodiments of the encoder 20 as shown in FIG. 20 may be further configured to partition and/or encode the picture using slices (also referred to as video slices), where a picture may be partitioned into or encoded using one or more slices (typically non-overlapping), and each slice may comprise one or more blocks (e.g. CTUs).

Embodiments of the encoder 20 as shown in FIG. 20 may be further configured to partition and/or encode the picture using tile groups (also referred to as video tile groups) and/or tiles (also referred to as video tiles), where a picture may be partitioned into or encoded using one or more tile groups (typically non-overlapping), and each tile group may comprise, e.g. one or more blocks (e.g. CTUs) or one or more tiles, where each tile, e.g. may be of rectangular shape and may comprise one or more blocks (e.g. CTUs), e.g. complete or fractional blocks.

FIG. 21 shows an example of a decoder 30 that is configured to implement the techniques of this present application. The decoder 30 is configured to receive encoded picture data 21 (e.g. encoded bitstream 21), e.g. encoded by encoder 20, to obtain a decoded picture 331. The encoded picture data or bitstream includes information for decoding the encoded picture data, e.g. data that represents picture blocks of an encoded slice (and/or tile groups or tiles or subpictures) and associated syntax elements.

The entropy decoding unit 304 is configured to parse the bitstream 21 (or in general encoded picture data 21) and perform, for example, entropy decoding to the encoded picture data 21 to obtain, e.g., quantized coefficients 309 and/or decoded coding parameters (not shown in FIG. 21), e.g. any or all of inter prediction parameters (e.g. reference picture index and motion vector), intra prediction parameter (e.g. intra prediction mode or index), transform parameters, quantization parameters, loop filter parameters, and/or other syntax elements. Entropy decoding unit 304 maybe configured to apply the decoding algorithms or schemes corresponding to the encoding schemes as described with regard to the entropy encoding unit 270 of the encoder 20. Entropy decoding unit 304 may be further configured to provide inter prediction parameters, intra prediction parameter and/or other syntax elements to the mode application unit 360 and other parameters to other units of the decoder 30. Decoder 30 may receive the syntax elements at the video slice level and/or the video block level. In addition or as an alternative to slices and respective syntax elements, tile groups and/or tiles and respective syntax elements may be received and/or used. The entropy decoding may implement any of the above mentioned arithmetic decoding methods or apparatuses.

The reconstruction unit 314 (e.g. adder or summer 314) may be configured to add the reconstructed residual block 313, to the prediction block 365 to obtain a reconstructed block 315 in the sample domain, e.g. by adding the sample values of the reconstructed residual block 313 and the sample values of the prediction block 365.

Embodiments of the decoder 30 as shown in FIG. 21 may be configured to partition and/or decode the picture using slices (also referred to as video slices), where a picture may be partitioned into or decoded using one or more slices (typically non-overlapping), and each slice may comprise one or more blocks (e.g. CTUs).

Embodiments of the decoder 30 as shown in FIG. 21 may be configured to partition and/or decode the picture using tile groups (also referred to as video tile groups) and/or tiles (also referred to as video tiles), where a picture may be partitioned into or decoded using one or more tile groups (typically non-overlapping), and each tile group may comprise, e.g. one or more blocks (e.g. CTUs) or one or more tiles, where each tile, e.g. may be of rectangular shape and may comprise one or more blocks (e.g. CTUs), e.g. complete or fractional blocks.

Other variations of the decoder 30 can be used to decode the encoded picture data 21. For example, the decoder 30 can produce the output video stream without the loop filtering unit 320. For example, a non-transform based decoder 30 can inverse-quantize the residual signal directly without the inverse-transform processing unit 312 for certain blocks or frames. In another implementation, the decoder 30 can have the inverse-quantization unit 310 and the inverse-transform processing unit 312 combined into a single unit.

It should be understood that, in the encoder 20 and the decoder 30, a processing result of a current step may be further processed and then output to the next step. For example, after interpolation filtering, motion vector derivation or loop filtering, a further operation, such as Clip or shift, may be performed on the processing result of the interpolation filtering, motion vector derivation or loop filtering.

### Implementations in Hardware and Software

Some further implementations in hardware and software are described in the following.

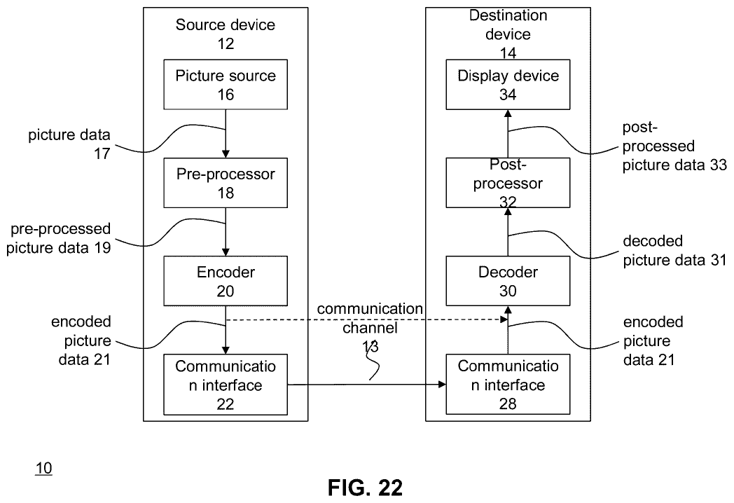

Any of the encoding devices described above with references to FIGS. 22-25 may provide means in order to carry out the above encoding method and decoding method. In particular, a processing circuitry within any of these exemplary devices is configured to carry out the above encoding method and decoding method.

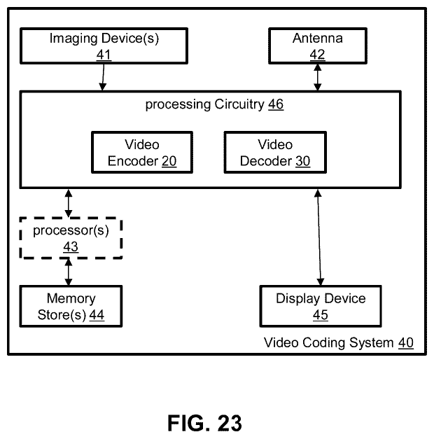

In the following embodiments of a coding system 10, an encoder 20 and a decoder 30 are described based on FIGS. 22 and 23, with reference to the above mentioned FIGS. 20 and 21 or other encoder and decoder such as a neural network based encoder and decoder.

FIG. 22 is a schematic block diagram illustrating an example coding system 10, e.g. a video coding system 10, or picture coding system 10, that may utilize techniques of this present application. Encoder 20 and decoder 30 of the coding system 10 represent examples of devices that may be configured to perform techniques in accordance with various examples described in the present application.

As shown in FIG. 22, the coding system 10 includes a source device 12 configured to provide encoded picture data 21 e.g. to a destination device 14 for decoding the encoded picture data 13.

The source device 12 includes an encoder 20, and may additionally, i.e. optionally, comprise a picture source 16, a pre-processor (or pre-processing unit) 18, e.g. a picture pre-processor 18, and a communication interface or communication unit 22. The source device 12 can be a cloud server, a content server or content delivery server.

The picture source 16 may comprise or be any kind of picture capturing device, for example a camera for capturing a real-world picture, and/or any kind of a picture generating device, for example a computer-graphics processor for generating a computer animated picture, or any kind of other device for obtaining and/or providing a real-world picture, a computer generated picture (e.g. a screen content, a virtual reality (VR) picture) and/or any combination thereof (e.g. an augmented reality (AR) picture). The picture source may be any kind of memory or storage storing any of the aforementioned pictures.

In distinction to the pre-processor 18 and the processing performed by the pre-processing unit 18, the picture or picture data 17 may also be referred to as raw picture or raw picture data 17.

Pre-processor 18 is configured to receive the (raw) picture data 17 and to perform pre-processing on the picture data 17 to obtain a pre-processed picture 19 or pre-processed picture data 19. Pre-processing performed by the pre-processor 18 may, e.g., comprise trimming, color format conversion (e.g. from RGB to YcbCr), color correction, or de-noising. It can be understood that the pre-processing unit 18 may be optional component.

The encoder 20 is configured to receive the pre-processed picture data 19 and provide encoded picture data 21 (further details were described above, e.g., based on FIG. 20).

Communication interface 22 of the source device 12 may be configured to receive the encoded picture data 21 and to transmit the encoded picture data 21 (or any further processed version thereof) over communication channel 13 to another device, e.g. the destination device 14 or any other device, for storage or direct reconstruction.

The destination device 14 includes a decoder 30, and may additionally, i.e. optionally, comprise a communication interface or communication unit 28, a post-processor 32 (or post-processing unit 32) and a display device 34.

The communication interface 28 of the destination device 14 is configured receive the encoded picture data 21 (or any further processed version thereof), e.g. directly from the source device 12 or from any other source, e.g. a storage device, e.g. an encoded picture data storage device, and provide the encoded picture data 21 to the decoder 30.

The communication interface 22 and the communication interface 28 may be configured to transmit or receive the encoded picture data 21 or encoded data 13 via a direct communication link between the source device 12 and the destination device 14, e.g. a direct wired or wireless connection, or via any kind of network, e.g. a wired or wireless network or any combination thereof, or any kind of private and public network, or any kind of combination thereof.

The communication interface 22 may be, e.g., configured to package the encoded picture data 21 into an appropriate format, e.g. packets, and/or process the encoded picture data using any kind of transmission encoding or processing for transmission over a communication link or communication network, or a transmission medium. The communication interface 22 may be, e.g., configured to encapsulating the encoded picture data to obtain a transport stream in a first format, and send the transport stream to a terminal-side apparatus for display; or, send the transport stream in the first format to storage space for storage.

The communication interface 28, forming the counterpart of the communication interface 22, may be, e.g., configured to receive the transmitted data and process the transmission data using any kind of corresponding transmission decoding or processing and/or de-packaging to obtain the encoded picture data 21.

Both, communication interface 22 and communication interface 28 may be configured as unidirectional communication interfaces as indicated by the arrow for the communication channel 13 in FIG. 22 pointing from the source device 12 to the destination device 14, or bi-directional communication interfaces, and may be configured, e.g. to send and receive messages, e.g. to set up a connection, to acknowledge and exchange any other information related to the communication link and/or data transmission, e.g. encoded picture data transmission.

The decoder 30 is configured to receive the encoded picture data 21 and provide decoded picture data 31 or a decoded picture 31 (further details were described above, e.g., based on FIG. 21).

The post-processor 32 of destination device 14 is configured to post-process the decoded picture data 31 (also called reconstructed picture data), e.g. the decoded picture 31, to obtain post-processed picture data 33, e.g. a post-processed picture 33. The post-processing performed by the post-processing unit 32 may comprise, e.g. color format conversion (e.g. from YcbCr to RGB), color correction, trimming, or re-sampling, or any other processing, e.g. for preparing the decoded picture data 31 for display, e.g. by display device 34.

The display device 34 of the destination device 14 is configured to receive the post-processed picture data 33 for displaying the picture, e.g. to a user or viewer. The display device 34 may be or comprise any kind of display for representing the reconstructed picture, e.g. an integrated or external display or monitor. The displays may, e.g. comprise liquid crystal displays (LCD), organic light emitting diodes (OLED) displays, plasma displays, projectors, micro LED displays, liquid crystal on silicon (LcoS), digital light processor (DLP) or any kind of other display.

Although FIG. 22 depicts the source device 12 and the destination device 14 as separate devices, embodiments of devices may also comprise both or both functionalities, the source device 12 or corresponding functionality and the destination device 14 or corresponding functionality. In such embodiments the source device 12 or corresponding functionality and the destination device 14 or corresponding functionality may be implemented using the same hardware and/or software or by separate hardware and/or software or any combination thereof.

As will be apparent for the skilled person based on the description, the existence and (exact) split of functionalities of the different units or functionalities within the source device 12 and/or destination device 14 as shown in FIG. 22 may vary depending on the actual device and application.

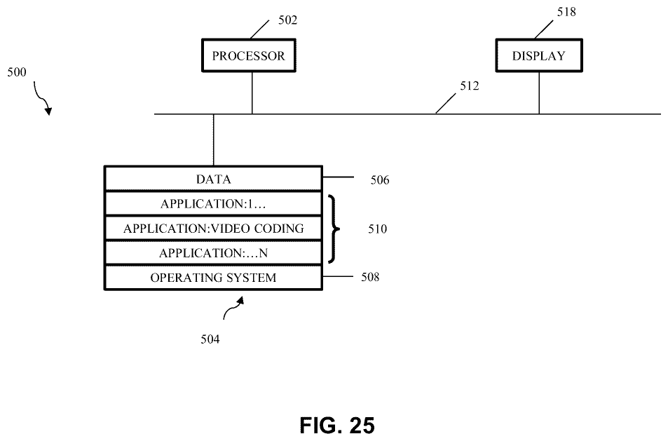

The encoder 20 or the decoder 30 or both encoder 20 and decoder 30 may be implemented via processing circuitry as shown in FIG. 23, such as one or more microprocessors, digital signal processors (DSPs), application-specific integrated circuits (ASICs), field-programmable gate arrays (FPGAs), discrete logic, hardware, video coding dedicated or any combinations thereof. The encoder 20 may be implemented via processing circuitry 46 to embody the various modules as discussed with respect to encoder 20 of FIG. 20 and/or any other encoder system or subsystem described herein. The decoder 30 may be implemented via processing circuitry 46 to embody the various modules as discussed with respect to decoder 30 of FIG. 21 and/or any other decoder system or subsystem described herein. The processing circuitry may be configured to perform the various operations as discussed later. As shown in FIG. 25, if the techniques are implemented partially in software, a device may store instructions for the software in a suitable, non-transitory computer-readable storage medium and may execute the instructions in hardware using one or more processors to perform the techniques of this disclosure. Either of encoder 20 and decoder 30 may be integrated as part of a combined encoder/decoder (CODEC) in a single device, for example, as shown in FIG. 23.

Source device 12 and destination device 14 may comprise any of a wide range of devices, including any kind of handheld or stationary devices, e.g. notebook or laptop computers, mobile phones, smart phones, tablets or tablet computers, cameras, desktop computers, set-top boxes, televisions, display devices, digital media players, video gaming consoles, video streaming devices (such as content services servers or content delivery servers), broadcast receiver device, broadcast transmitter device, or the like and may use no or any kind of operating system. In some cases, the source device 12 and the destination device 14 may be equipped for wireless communication. Thus, the source device 12 and the destination device 14 may be wireless communication devices.

In some cases, video coding system 10 illustrated in FIG. 22 is merely an example and the techniques of the present application may apply to coding settings (e.g., video/image encoding or video/image decoding) that do not necessarily include any data communication between the encoding and decoding devices. In other examples, data is retrieved from a local memory, streamed over a network, or the like. An encoding device may encode and store data to memory, and/or a decoding device may retrieve and decode data from memory. In some examples, the encoding and decoding is performed by devices that do not communicate with one another, but simply encode data to memory and/or retrieve and decode data from memory.

For convenience of description, embodiments of the invention are described herein, for example, by reference to High-Efficiency Video Coding (HEVC) or to the reference software of Versatile Video coding (VVC), the next generation video coding standard developed by the Joint Collaboration Team on Video Coding (JCT-VC) of ITU-T Video Coding Experts Group (VCEG) and ISO/IEC Motion Picture Experts Group (MPEG). One of ordinary skill in the art will understand that embodiments of the invention are not limited to HEVC or VVC.

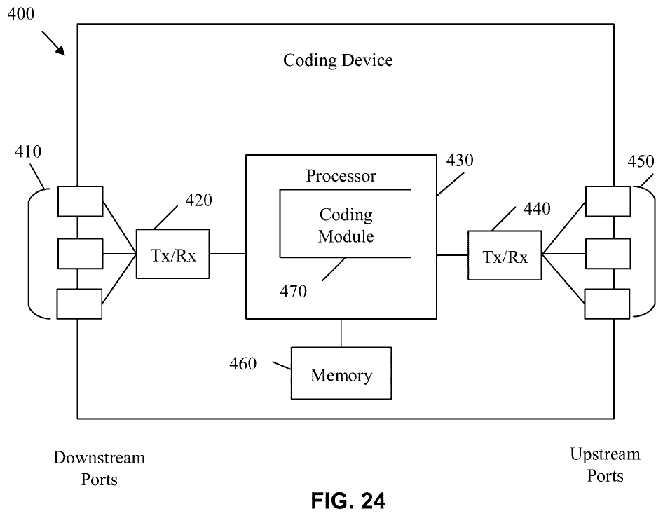

FIG. 24 is a schematic diagram of a coding device 400 (video coding device or image coding device) according to an embodiment of the disclosure. The coding device 400 is suitable for implementing the disclosed embodiments as described herein. In an embodiment, the coding device 400 may be a decoder such as decoder 30 of FIG. 22 or an encoder such as encoder 20 of FIG. 22.

The coding device 400 includes ingress ports 410 (or input ports 410) and receiver units (Rx) 420 for receiving data; a processor, logic unit, or central processing unit (CPU) 430 to process the data; transmitter units (Tx) 440 and egress ports 450 (or output ports 450) for transmitting the data; and a memory 460 for storing the data. The coding device 400 may also comprise optical-to-electrical (OE) components and electrical-to-optical (EO) components coupled to the ingress ports 410, the receiver units 420, the transmitter units 440, and the egress ports 450 for egress or ingress of optical or electrical signals.

The processor 430 is implemented by hardware and software. The processor 430 may be implemented as one or more CPU chips, cores (e.g., as a multi-core processor), FPGAs, ASICs, and DSPs. The processor 430 is in communication with the ingress ports 410, receiver units 420, transmitter units 440, egress ports 450, and memory 460. The processor 430 includes a coding module 470. The coding module 470 implements the disclosed embodiments described above. For instance, the coding module 470 implements, processes, prepares, or provides the various coding operations. The inclusion of the coding module 470 therefore provides a substantial improvement to the functionality of the video coding device 400 and effects a transformation of the video coding device 400 to a different state. Alternatively, the coding module 470 is implemented as instructions stored in the memory 460 and executed by the processor 430.

The memory 460 may comprise one or more disks, tape drives, and solid-state drives and may be used as an over-flow data storage device, to store programs when such programs are selected for execution, and to store instructions and data that are read during program execution. The memory 460 may be, for example, volatile and/or non-volatile and may be a read-only memory (ROM), random access memory (RAM), ternary content-addressable memory (TCAM), and/or static random-access memory (SRAM).

FIG. 25 is a simplified block diagram of an apparatus 500 that may be used as either or both of the source device 12 and the destination device 14 from FIG. 22 according to an exemplary embodiment.

A processor 502 in the apparatus 500 can be a central processing unit. Alternatively, the processor 502 can be any other type of device, or multiple devices, capable of manipulating or processing information now-existing or hereafter developed. Although the disclosed implementations can be practiced with a single processor as shown, e.g., the processor 502, advantages in speed and efficiency can be achieved using more than one processor.

A memory 504 in the apparatus 500 can be a read only memory (ROM) device or a random access memory (RAM) device in an implementation. Any other suitable type of storage device can be used as the memory 504. The memory 504 can include code and data 506 that is accessed by the processor 502 using a bus 512. The memory 504 can further include an operating system 508 and application programs 510, the application programs 510 including at least one program that permits the processor 502 to perform the methods described here. For example, the application programs 510 can include applications 1 through N, which further include a video coding application that performs the methods described herein, including the encoding and decoding using arithmetic coding as described above.

The apparatus 500 can also include one or more output devices, such as a display 518. The display 518 may be, in one example, a touch sensitive display that combines a display with a touch sensitive element that is operable to sense touch inputs. The display 518 can be coupled to the processor 502 via the bus 512.

Although depicted here as a single bus, the bus 512 of the apparatus 500 can be composed of multiple buses. Further, a secondary storage 514 can be directly coupled to the other components of the apparatus 500 or can be accessed via a network and can comprise a single integrated unit such as a memory card or multiple units such as multiple memory cards. The apparatus 500 can thus be implemented in a wide variety of configurations.

It should be noted that embodiments of the coding system 10, encoder 20 and decoder 30 (and correspondingly the system 10) and the other embodiments described herein may be configured for video, still picture processing or coding, i.e. the processing or coding of an individual picture independent of any preceding or consecutive picture as in video coding. In general only inter-prediction units 244 (encoder) and 344 (decoder) may not be available in case the picture processing coding is limited to a single picture 17. All other functionalities (also referred to as tools or technologies) of the encoder 20 and decoder 30 may equally be used for still picture processing, e.g. residual calculation 204/304, transform 206, quantization 208, inverse quantization 210/310, (inverse) transform 212/312, partitioning 262/362, intra-prediction 254/354, and/or loop filtering 220, 320, and entropy coding 270 and entropy decoding 304.

Embodiments, e.g. of the encoder 20 and the decoder 30, and functions described herein, e.g. with reference to the encoder 20 and the decoder 30, may be implemented in hardware, software, firmware, or any combination thereof. If implemented in software, the functions may be stored on a computer-readable medium or transmitted over communication media as one or more instructions or code and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

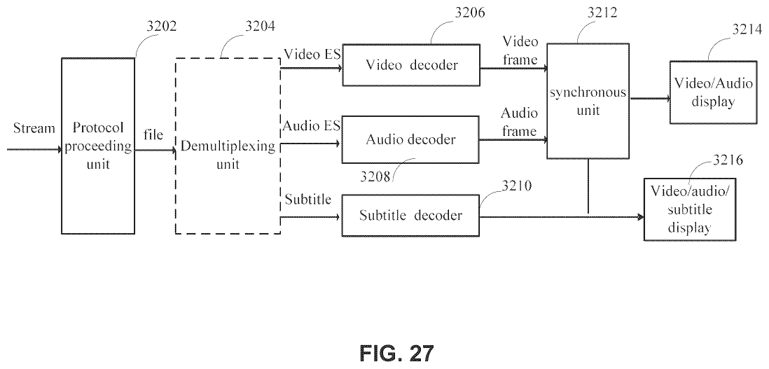

FIG. 27 is a block diagram showing a content supply system 3100 for realizing content distribution service. This content supply system 3100 includes capture device 3102, terminal device 3106, and optionally includes display 3126. The capture device 3102 communicates with the terminal device 3106 over communication link 3104. The communication link may include the communication channel 13 described above. The communication link 3104 includes but not limited to WIFI, Ethernet, Cable, wireless (3G/4G/5G), USB, or any kind of combination thereof, or the like.

The capture device 3102 generates data, and may encode the data by the encoding method as shown in the above embodiments. Alternatively, the capture device 3102 may distribute the data to a streaming server (not shown in the Figures), and the server encodes the data and transmits the encoded data to the terminal device 3106. The capture device 3102 includes but not limited to camera, smart phone or Pad, computer or laptop, video conference system, PDA, vehicle mounted device, or a combination of any of them, or the like. For example, the capture device 3102 may include the source device 12 as described above. When the data includes video, the video encoder 20 included in the capture device 3102 may actually perform video encoding processing. When the data includes audio (i.e., voice), an audio encoder included in the capture device 3102 may actually perform audio encoding processing. For some practical scenarios, the capture device 3102 distributes the encoded video and audio data by multiplexing them together. For other practical scenarios, for example in the video conference system, the encoded audio data and the encoded video data are not multiplexed. Capture device 3102 distributes the encoded audio data and the encoded video data to the terminal device 3106 separately.

In the content supply system 3100, the terminal device 310 receives and reproduces the encoded data. The terminal device 3106 could be a device with data receiving and recovering capability, such as smart phone or Pad 3108, computer or laptop 3110, network video recorder (NVR)/digital video recorder (DVR) 3112, TV 3114, set top box (STB) 3116, video conference system 3118, video surveillance system 3120, personal digital assistant (PDA) 3122, vehicle mounted device 3124, or a combination of any of them, or the like capable of decoding the above-mentioned encoded data. For example, the terminal device 3106 may include the destination device 14 as described above. When the encoded data includes video, the video decoder 30 included in the terminal device is prioritized to perform video decoding. When the encoded data includes audio, an audio decoder included in the terminal device is prioritized to perform audio decoding processing.

For a terminal device with its display, for example, smart phone or Pad 3108, computer or laptop 3110, network video recorder (NVR)/digital video recorder (DVR) 3112, TV 3114, personal digital assistant (PDA) 3122, or vehicle mounted device 3124, the terminal device can feed the decoded data to its display. For a terminal device equipped with no display, for example, STB 3116, video conference system 3118, or video surveillance system 3120, an external display 3126 is contacted therein to receive and show the decoded data.

When each device in this system performs encoding or decoding, the picture encoding device or the picture decoding device, as shown in the above-mentioned embodiments, can be used.

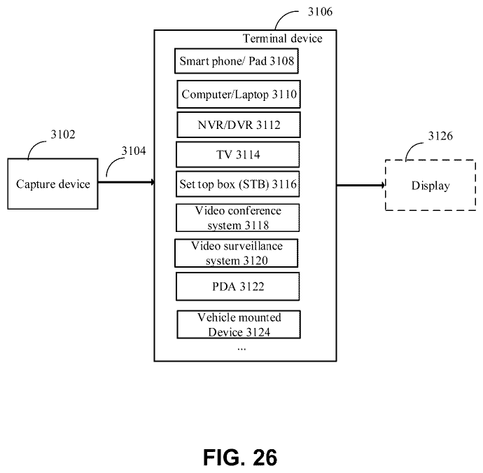

FIG. 26 is a diagram showing a structure of an example of the terminal device 3106. After the terminal device 3106 receives stream from the capture device 3102, the protocol proceeding unit 3202 analyzes the transmission protocol of the stream. The protocol includes but not limited to Real Time Streaming Protocol (RTSP), Hyper Text Transfer Protocol (HTTP), HTTP Live streaming protocol (HLS), MPEG-DASH, Real-time Transport protocol (RTP), Real Time Messaging Protocol (RTMP), or any kind of combination thereof, or the like.

After the protocol proceeding unit 3202 processes the stream, stream file is generated. The file is outputted to a demultiplexing unit 3204. The demultiplexing unit 3204 can separate the multiplexed data into the encoded audio data and the encoded video data. As described above, for some practical scenarios, for example in the video conference system, the encoded audio data and the encoded video data are not multiplexed. In this situation, the encoded data is transmitted to video decoder 3206 and audio decoder 3208 without through the demultiplexing unit 3204.

Via the demultiplexing processing, video elementary stream (ES), audio ES, and optionally subtitle are generated. The video decoder 3206, which includes the video decoder 30 as explained in the above mentioned embodiments, decodes the video ES by the decoding method as shown in the above-mentioned embodiments to generate video frame, and feeds this data to the synchronous unit 3212. The audio decoder 3208, decodes the audio ES to generate audio frame, and feeds this data to the synchronous unit 3212. Alternatively, the video frame may store in a buffer (not shown in FIG. 26) before feeding it to the synchronous unit 3212. Similarly, the audio frame may store in a buffer (not shown in FIG. 26) before feeding it to the synchronous unit 3212.

The synchronous unit 3212 synchronizes the video frame and the audio frame, and supplies the video/audio to a video/audio display 3214. For example, the synchronous unit 3212 synchronizes the presentation of the video and audio information. Information may code in the syntax using time stamps concerning the presentation of coded audio and visual data and time stamps concerning the delivery of the data stream itself.

If subtitle is included in the stream, the subtitle decoder 3210 decodes the subtitle, and synchronizes it with the video frame and the audio frame, and supplies the video/audio/subtitle to a video/audio/subtitle display 3216.

The present invention is not limited to the above-mentioned system, and either the picture encoding device or the picture decoding device in the above-mentioned embodiments can be incorporated into other system, for example, a car system.

By way of example, and not limiting, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, a cloud server, an application server, an integrated circuit (IC) or a set of Ics (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

What is claimed is:

1. A decoding method, implemented by a decoder, comprising:
receiving a bitstream including encoded data of an input signal and a first parameter;
parsing the bitstream to obtain the first parameter;
obtaining an entropy coding parameter based on the first parameter; and
reconstructing at least a portion of the input signal, based on the entropy coding parameter and the encoded data.

2. The decoding method according to claim 1, wherein the entropy coding parameter comprises at least one of the following:
a size of an alphabet of an entropy coder, wherein the size of the alphabet is: a size of an input alphabet of an entropy encoder, or a size of an output alphabet of an entropy decoder; or
a minimum symbol probability supported by the entropy coder; or
a renormalization period of the entropy coder.

3. The decoding method according to claim 1 wherein the first parameter is p, the entropy coding parameter comprises a size of an alphabet M, and M is a function of p.

4. The decoding method according to claim 3, wherein the M meets one of the following:
M=k^{a*p+C}, wherein k is a natural number, a and C are constants; or,
M=a*p+b, wherein a and b are constants; or,
M=p².

5. The decoding method according to claim 4, wherein p=log₂(M)−9, and
M=f⁻¹(p)=2^{p+9}.

6. The decoding method according to claim 1, wherein the first parameter comprises at least one of the following: a rate control parameter, a quantization parameter (qp), image resolution, video resolution, framerate, density of pixels in 3D object, or rate-distortion weighting factor.

7. The decoding method according to claim 6, wherein the obtaining the entropy coding parameter based on the first parameter, comprising:
determining a target sub-range in which the first parameter is located; wherein an allowed range of values of the first parameter comprises a plurality of sub-ranges, the target sub-range is one of the plurality of sub-ranges; and each of the plurality of sub-ranges comprises at least one value of the first parameter, and each of the plurality of sub-ranges corresponds to one value of the entropy coding parameter;
using a value of the entropy coding parameter corresponding to the target sub-range as the value of the entropy coding parameter; or,
calculating the value of the entropy coding parameter based on one or more values of the entropy coding parameter corresponding to one or more sub-ranges neighboring the target sub-range.

8. The decoding method according to claim 1, wherein the decoding method further comprising:
parsing the bitstream to obtain a flag, wherein the flag is used to indicate whether the entropy coding parameter is carried in the bitstream directly.

9. The decoding method according to claim 8,
wherein when the flag is equal to a first value specifies that the entropy coding parameter is carried in the bitstream, and in this case, the first parameter is the entropy coding parameter or the first parameter is a transformation result of the entropy coding parameter; or
wherein when the flag is equal to a second value specifies that the entropy coding parameter is not carried in the bitstream, the entropy coding parameter is derived by the decoder.

10. An encoding method, implemented by an encoder, comprising:
encoding input signal and a first parameter into a bitstream, wherein the first parameter is used to obtain an entropy coding parameter; and
transmitting the bitstream to a decoder.

11. The encoding method according to claim 10, wherein the entropy coding parameter comprises at least one of the following:
a size of an alphabet of an entropy coder, wherein the size of the alphabet is: a size of an input alphabet of an entropy encoder, or a size of an output alphabet of an entropy decoder; or
a minimum symbol probability supported by the entropy coder; or
a renormalization period of the entropy coder.

12. The encoding method according to claim 10, wherein the first parameter is p,
wherein p is a transformation result of M, and M is the entropy coding parameter.

13. The encoding method according to claim 12, wherein p=f(M), wherein f(M) comprises as follows:
f(M)=a*logₖ(M)+b, wherein k is a natural number, a and b are constants; or,
f(M)=a*M+b, wherein a and b are constants; or,
f(M)=sqrt (M).

14. The encoding method according to claim 13, wherein p=log₂(M)−9.

15. A decoder, comprising:
one or more processors; and
a computer-readable storage medium coupled to the one or more processors, wherein the storage medium stores programming for execution by the one or more processors, wherein the programming, when executed by the one or more processors, configures the decoder to:
receive a bitstream including encoded data of an input signal and a first parameter;
parse the bitstream to obtain the first parameter;
obtain an entropy coding parameter based on the first parameter; and
reconstruct at least a portion of the input signal, based on the entropy coding parameter and the encoded data.

16. The decoder of claim 15, wherein the entropy coding parameter comprises at least one of the following:
a size of an alphabet of an entropy coder, wherein the size of the alphabet is: a size of an input alphabet of an entropy encoder, or a size of an output alphabet of an entropy decoder; or
a minimum symbol probability supported by the entropy coder; or
a renormalization period of the entropy coder.

17. The decoder of claim 15, wherein the first parameter is p, the entropy coding parameter comprises a size of a alphabet M, and M is a function of p.

18. The decoder of claim 17, wherein the M meets one of the following:
M=k^{a*p+C}, wherein k is a natural number, a and C are constants; or,
M=a*p+b, wherein a and b are constants; or,
M=p².

19. The decoder of claim 18, wherein p=log₂(M)−9, and M=f⁻¹(p)=2^{p+9}.

20. The decoder of claim 15, wherein the first parameter comprises at least one of the following: a rate control parameter, a quantization parameter (qp), an image resolution, a video resolution, framerate, a density of pixels in 3D object, or a rate-distortion weighting factor.
